(19) United States
(12) Patent Application Publication
(10) Pub. No.: US 2004/0068536 A1
(43) Pub. Date: Apr. 8, 2004

(54) Multimedia player and browser system

(76) Inventors: Timothy B. Demers, Tulsa, OK (US); Donald C. Kern, St. Broken Arrow, OK (US); Steven P. Reiser, Broken Arrow, OK (US); Christopher M. Patterson, Broken Arrow, OK (US); Doug E. Naufel, Broken Arrow, OK (US); Steven C. Williamson, Tulsa, OK (US)

Correspondence Address: Thomas L McMasters, Fredrikson & Byron, 4000 Pillsbury Center, 200 South Sixth Street, Minneapolis, MN, 55402-1425, US

(21) Appl. No.: 10/332,754

(22) PCT Filed: Jul. 16, 2001
(86) PCT No.: PCT/US01/22316

(30) Foreign Application Priority Data
Jul. 14, 2000 (US) 09616219

(51) Int. Cl. G06F 15/16

(52) U.S. Cl. 709/201

(57) ABSTRACT

A multimedia software application that can include audio, video and/or graphics, in a manner that combines the multimedia experience with the transfer of information from and between a variety of sources (126), in a variety of directions, and subject to a variety of prompts. The application provides a “Web in Page” approach, in which a series of windows have the same or similar “look and feel”, yet can be used to access and display information from a variety of sources (126), including local content (112) (hard drive or other locally stored media), and web-based online content (118), including that available from a dedicated, integrated server (114), affiliated servers (114), or even other computer users. The application of the present invention can be provided in stand-alone form, to be loaded on a client device (116) (e.g., personal computer) from either a recorded medium or downloaded online. In addition to this “Web in Page” application interface, a “Web in Skin” interface may be provided, by which the application interface may be varied based on client user (110) or advertiser (126) preferences to provide a customized interface format Optionally, and preferably, the application is provided in a form where it is recorded on, and thereby combined with, digitally recorded content, such as a music CD or DVD.

### CROSS-REFERENCE TO RELATED APPLICATIONS

This application claims the benefit of U.S. patent application Ser. No. 09/616,219, filed Jul. 14, 2000, which is incorporated herein by reference.

### TECHNICAL FIELD

In one aspect the present invention relates to media or multimedia (e.g., audiovisual graphics) players, and to the corresponding audio, visual and graphics content played with such players. In another aspect, the invention relates to Internet browsers and servers. In yet another aspect, the invention relates to the burgeoning field of “targeted” electronic commerce.

### BACKGROUND OF THE INVENTION

In North America, because of the flat fee structure in place for Internet usage, many computers are online most of the time, or are connected to the Internet for extended periods of time. There is estimated to be an installed base of over 100 million computers PCs in the U.S., alone, with nearly as many online users. A 1999 report estimated that 67.5 million PCs in the U.S., well over 50% of the computers, were connected to the Internet. Many of these newly connected PCs are in the workplace segment. It has also been estimated that three-quarters of the PCs purchased were accessing the Internet by the end of the year.

Other studies have indicated that home PC usage in the U.S. has surpassed 1 billion hours per week, with 53 percent of that time being spent online. Households are using their PCs more than 20 hours per week, on average, for personal purposes. Most businesses in the U.S. are connected to the Internet on a 24 hours-per-day-basis, and nearly all of them are connected to the Web during the business day.

In other parts of the world (e.g. parts of Europe, for example) countries currently charge for local telephone connection time. This has created a different usage pattern than that seen in North America on the World Wide Web in countries with these local charging schemes. Despite this impediment, the amount of time that European at-home Internet users spend online has risen dramatically during the last year. For example, the total monthly time online increased by 94 percent in Britain from June 2000 to February 2001. During the same period, it increased by 225 percent in France and 226 percent in Germany. The average time spent online per unique visitor each month was highest in Germany (more than 13 hours), followed by Spain (more than 9 hours), Norway (9 hours) and Italy (8 hours). Forecasts predict 64 million European households with PC-based Internet access by 2004. Currently, there are 25 million households in Western Europe with PC-based Internet access, linked in part to plummeting access costs for Internet usage.

It has been estimated that annual worldwide PC sales will grow from 124 million units in 2000 to more than 217 million in 2005. The North American region, and the U.S. in particular, will remain the leading regions for PC sales for at least five more years. Mobile PCs, including notebook and handheld models, will grow from 26.5 million units in 1999 to nearly 59 million in 2005.

The computers used to access the Internet are also becoming more powerful, and have greater storage capacity. The storage capacity of the standard disk drive shipped in 1997 was typically only 1.6-2.0 Gigabytes. Hard drives used in today's PCs, however, typically have capacities of 3.2 to 20.4 GB, and industry analysts expect average hard drive capacities for PCs to exceed 40 GB per drive by 2002. Today, a 25 Gigabyte hard drive is only about 2.5 inches wide and weighs less than 8 ounces, so the clear trend in computing is for bigger, faster, better disk capacity. Industry-wide, hard drive capacity has grown an average of about 60 percent per year since 1991. The average capacity during 2001 is 20.9 Gigabytes per PC shipped. In addition, other local storage solutions are making users less dependant on the hard drive, thus freeing up space there. These solutions include tape drives, removable high-density magnetic disks, and writable and re-writable optical media.

A commonly used system for use on Internet-connected PCs is an application server.

An application server is a server program that resides in a server (computer) and provides the processing for the application program. The server can be a part of the network, or more precisely is part of the distributed network. The server program is a program that provides its services to a client program, that resides either in the same computer or on another computer connected through the network.

Application servers are mainly used in Web-based applications that have a 3-tier architecture. The application server is typically a second/middle tier of, and an integral part of, the three-tier architecture. The application server syncs and combines with the Web server for processing requests made by remote clients.

In the request-response flow between client, Web server and application server, the client's request first goes to the Web server, which then sends the required information to the application server. It then sends the response back to the Web server after taking an appropriate action. The Web server then sends the processed information back to the client. Web servers use different approaches or technology for forwarding or receiving back processed information. Some of the most common approaches include CGI (Common Gateway Interface, can be written either in JAVA, C, C++, or Perl), Fast CGI, ASP (Active Server Pages), JSP (Java Server Pages), Java Servlets, and Java Script (Server Side).

Another popular Internet technology is that of the media player. The development and improvement of multimedia players has proceeded at a significant pace over the past decade. Audio and video servers deliver multimedia capabilities to Web sites by giving users the ability to listen to sound recordings and watch movie clips via Web browser plug-ins. While the use of traditional AN formats like WAV and MIDI (sound) or MOV and AVI (video) on a Web sites doesn't necessitate a specialized server, the recent emergence of streamed audio and video content, and generally multimedia on-demand, has made an Audio/Video Server a necessity in many cases. In some cases, protections are implemented to prevent piracy, such as digital watermarking and other encryption, to ensure that downloaded audio content is managed only by licensed parties. In addition, copyright information for the files may be incorporated within the downloaded files and on the server itself. Furthermore, some streaming offerings select streaming transmissions rates based on the server connection quality and the overall performance on the Internet at that specific time.

Many of these server technologies require similar client-side support: The remote user nay download executable code, often as freeware, such as a standalone client application to run on their local machine, or a plug-in or applet that works in conjunction with an Internet browser application. This plug-in may also prompt the user to download updated plug-in clients that become available. A more advanced plug-in may also be provided, often having increased functionality or allowing the use of technology or file formats other than that supported by the freeware plug-in, thus providing increased versatility and allowing the client user to possibly replace or eliminate a number of other plug-ins they may currently use. The technology developer or owner may also provide the server technology to others for use on their servers for a fee. There are currently several offerings among A/V servers: The Crescendo Streamsite product, for example, makes it possible for users to listen to background MIDI music while browsing Web sites. This product is designed to allow streaming of MIDI music over the Web. Streaming refers to the ability to listen to audio content while it is being downloaded as opposed to having to wait until after the file has been completely downloaded. StreamSite covers the server side of the MIDI streaming technology by enabling Web sites to serve their own streamed MIDI files to users of the Crescendo plug-in modules. The Crescendo technology is limited to MIDI music, and doesn't support WAV, AU, and RealPlayer files.

The Liquid Music System is marketed primarily to online music publishers. The audio system consists of a music player (for playing files), a mastering and encoding utility, and a server utility. Audio files from a Liquid Music server can either be sampled in short clips of streaming audio by the player or purchased and downloaded as local files for further listening. Liquid Music Server incorporates Dolby Digital technology to provide CD-quality audio. In addition, other information such as artist and song related text can be sent along with the audio and displayed by the player. This information is stored in a SQL file and transferred via either an ODBC or a direct SQL or Oracle connection. The SQL database can be located on a network's SQL server or on a separate server, allowing distribution over a network.

Microsoft's NetShow has offered Advanced Streaming Format (ASF), a real-time audio and video streaming technology, comparable to RealNetworks' RealVideo and RealAudio (RA/RV) streaming technology. NetShow delivers compatibility with several existing real-time audio and video formats, and offers the ability to create and serve both live and on-demand multimedia content, including MPEG-quality full-motion, full-screen video across high-bandwidth networks and dedicated video LANs.

The RealServer G2 technology used by RealNetworks takes advantage of ever-faster connections to the Internet, and uses data compression, to support streaming using the W3C standard Synchronized Multimedia Integration Language (SMIL), which allows for the layout and synchronization of multiple data types, including the multistream data types RealPix, RealText and RealFlash.

A protocol for streaming audio, RTSP (Real Time Streaming Protocol) is used, and other Web-oriented multimedia formats are supported in native form, including ASF, AVI, JPEG, MPEG, VIV, WAV, and QSound Lab's iQfx. FRU (frame rate upsampling) supplies video at up to 30 frames per second. Load balancing between multiple servers, multicast IP capabilities, and scalable multicasting capabilities are also supported by this product.

Components of the RealPlayer G2 system include a freeware and upgraded player, a producer program for encoding and organizing the content, and a server for serving the data. These components may be used to create web pages with embedded streaming media and have the client simultaneously upload the proper files to the correct RealServer G2 directory or to a page hosted by an ISP. Many ISPs have implemented RealNetwork technology and make the server available to their customers. RealVideo G2 supports Intel's Streaming Web Video technology, which provides automatic multi-rate streaming video content, as well as SureStream a transport technology that delivers reliable and continuous streaming data under less-than-optimal network conditions regardless of connection rates. Also provided are Web-based administration and monitoring capabilities, which are extensible both via HTML and through a server-side API. In certain versions, Real Player G2 includes password protection, and payment schemes can be used to provide pay-for-view events and to sell premium content protected by a password-authentication system.

Xing's StreamWorks offers real-time layer 1 and 2 MPEG audio and layer 1 video technology for Windows 95/NT platforms. However, at low bandwidths such as 33.6, 56, and particularly 14.4 Kbps, real-time video and audio quality may be impacted. A similar client, VDOLive, offers integration with certain Internet browser's for inline support of real-time audio and video. The VDOLive server program offers streamed multimedia content both on the Internet and on private Intranets. VDOlive also produces a standard commercial server that features on-demand and broadcast capabilities, support for an unlimited number of streams, and scalable video up to 512 Kbps per stream. While the standard server can serve live video streams, it requires an additional solution for encoding of these streams. The VDOLive Broadcast Station can encode a live video feed in real-time and pass it to a standard server where it may then be streamed to end users. Vosaic Media Server, based on the MPEG-1 and MPEG-2 compression formats, separates audio and video content into separate streams (which is beneficial for maintaining audio and video synchronization in high-traffic situations) while providing a Java-based client that can be run on any Web server, supporting a high frame rate (15 fps to 30 fps) in high-bandwidth situations.

U.S. Pat. No. 6,047,292 to Kelly, et al., describes a CD having both audio, visual, application and browsing functions on the same media. The application permits the user to both play individual items of audio or video and to also link to related web pages and web sites.

U.S. Pat. No. 5,861,881 (Freeman, et al.), describes an interactive computer system operable on a computer network. Multiple video/audio data streams may be received from a broadcast transmission source or may be resident in local or external storage. In response to user inputs, a personalized graphics, video and/or audio presentation is provided to the user either immediately or at a later time.

Currently, advertising and product or service promotion may be accomplished by various means that do not utilize streaming or network multimedia technologies. For example, promotion may consist of point-of-purchase modalities (e.g., brochures, catalogs, gift with purchase, product samples, displays), Internet advertising (SMTP mail, banner ads, other content), analog or traditional broadcast (television, radio), print (direct mail, magazines, and billboards). Each of these promotional modalities may involve significant cost, particularly catalogs, for example. However, such marketing vehicles are relatively static and scattershot, i.e., is directed towards a broad target audience which may not comprise a sufficiently focused group to provide efficient promotion. It would be desirable to provide a more concentrated market segment or target population that could be marketed to cheaply and efficiently.

The various applications above provide a variety of media delivery alternatives. What they collectively lack, however, are a combination of features that provide even greater opportunities to the client user, and ultimately, to the “e-commerce” (i.e., electronic commerce) provider and customer, particularly by integrating a sales or licensing modality with the client player modality. In addition, the above systems fail to provide a transparent method of data streaming and linking that is unobtrusive to the low-bandwidth client.

### SUMMARY OF THE INVENTION

The present invention provides a software application that provides a multimedia experience that can include audio, video and/or graphics, in a manner that combines the multimedia experience with the transfer of information from and between a variety of sources, in a variety of directions, and subject to a variety of prompts. Such a multimedia experience can be used for a corresponding variety of purposes, for instance in the travel industry (with respect to travel destinations) or real estate industry (with respect to available properties), but is particularly well-suited to the music and entertainment industries. Regardless of the industry involved however, the present invention provides a multimedia functionality and delivery system that is tightly integrated with a commerce or promotional system. In a representative embodiment, the invention provides for a central server system, that transmit multimedia content to remote client users, and transform costly, static promotional programs into interactive, high impact, continuous campaigns.

Because the product of the multimedia industry may be promoted in a manner which delivers the content itself, the multimedia industry may be expected to prove particularly suitable for the present invention, an aspect of which is a cycle of promotion and user-reaction resulting in a user-directed sale. For purposes of the present invention, the term broadcast is sometimes used to describe a transmission from the Server Administrator's server to the client machine. However, the transmission is not a broadcast in the formal sense of being a simultaneous delivery in real-time to a large number of clients.

The instant invention provides a unique opportunity to merge both local (i.e., resident on the remote user computer) and online content in an integrated and seamless manner. According to one embodiment, the application provides what may be termed a “Web in Page” approach, in which a series of windows or interfaces have the same or similar “look and feel”, yet can be used to access and display information from a variety of sources, including local content. This local content may be, for example, hard drive or other similar digitally-recorded media, and web-based online content, including that available from a dedicated, integrated server, affiliated servers, or even other computer users. An executable according to an embodiment of the present invention can be provided as a stand-alone application, to be loaded on a client device (e.g., personal computer) from either a physical recorded medium, or downloaded online. Optionally, and preferably, the application is provided in a form where it is recorded on, and thereby combined with, digitally recorded content, such as a music CD or music or video DVD. In the course of loading the CD/DVD, the user can automatically load the executable as well, in a manner that permits online access and interface with the dedicated server or other sites. Once the local content is accessed, and connection with an Internet site is established, the user is able to move between the local and online sources in a seamless and controllable fashion, while at the same time, the server is able to seek, make available, and/or direct additional information toward the user, in either a prompted or unprompted fashion.

With respect to music, for instance, the application provides the ability to play and display a music CD or DVD in a manner that permits the user to simultaneously display lyrics, and/or to immediately access related information concerning the artist or selection. Such information can include, for instance, local content available from the CD/DVD itself (e.g., artist, selection, credits, lyrics) as well as online content such as tour dates and current ticket information and ordering, merchandise availability and ordering, live interviews, artist information, and other related information. For information beyond that accessible by either the local content or dedicated/affiliated server sites or databases, the application provides an integrated browser function, and/or the ability to link to the user's browser in order to access the Internet in its entirety.

Moreover, and by virtue of the online connection made between the client and the dedicated server, an entire world of focused and targeted electronic commerce becomes available. The dedicated server (or any of its affiliated sites) is able to direct content to the user, e.g., in a manner responsive or specific to the user's requests or profile.

The present invention therefore provides in one embodiment, an article of manufacture for use in a computer, Personal Digital Assistant (PDA), Web-enabled phone or other digital device, comprising local storage or memory, such as a disc or RAM, and an application as presently described. The invention further provides a computer executable program for controlling a computer, the program comprising a recording medium readable by the computer, and means on the recording medium for providing the player and browser components of an application as described herein.

In yet another aspect, the invention provides a data provider stored on computer readable medium, the data provider comprising a first plurality of computer instructions, which when provided to a central processing unit (“CPU”) directs the processing unit in a manner that provides the player functions described herein, and a second plurality of computer instructions, which when provided to a CPU provides the browser functions described herein. In a similar aspect, the invention provides a data provider stored on computer readable medium, wherein the data provider is executable by a CPU, the data provider, when executed by the CPU causes the CPU to comprise sort circuitry which provides a list of sorted items as described herein, identification circuitry which identifies a selected item in the list of sorted items, and transmission circuitry which transmits the selected item.

For instance, the invention provides a computer program for controlling a computer, the program comprising a recording medium readable by the computer, and means on the recording medium for providing both a multimedia player component and an integrated Internet browser component, wherein the program permits a user to play one or more items of multimedia and to access the Internet in an integrated fashion. Preferably, the invention provides a computer program wherein access to the Internet is provided in the form of access to a dedicated and/or affiliated server sites adapted to provide related content, and more preferably, wherein access to the Internet further comprises a conventional browser in order to provide access to unaffiliated server sites. In a further embodiment, the invention provides a computer program as described herein, further comprising one or more items of multimedia content, preferably selected from music and corresponding video and graphics.

In a related embodiment, the invention provides an article of manufacture for use in a computer, comprising a computer readable (e.g. digital) recording medium comprising an application as described herein, as well as a system comprising a computer program as described herein, in combination with a dedicated server adapted to be linked by the browser in order to provide related content. Similarly, the invention provides a method of providing multimedia, the method comprising the steps of providing a computer program as described herein, loading the computer program on a client computer, establishing a connection between the Internet and the client computer, and employing the program to both play one or more items of multimedia content and access the Internet for related content.

The present invention further provides in several embodiments for various marketing-related modalities which provide a powerful targeted message to a group that is highly refined in terms of the likelihood of their effecting a purchase. Because of the commercial power of such a model is extensive, it may be anticipated that entities having marketing objectives may approach the Server Administrator to carry out an advertising or promotional campaign. These entities may fairly be termed “clients” of the Server Administrator. However, for purposes of the instant application, the parties seeking promotional services from the Server Administrator will be termed generally advertisers, so as to avoid confusion with the client machine or process that is remote from the Server Administrator. Additionally, parties in addition to advertisers may provide content to the Server Administrator; for example, a customer of the Server Administrator may be interested in distributing content that is not an advertisement, such as multimedia artistic works or sound recordings. Accordingly, the terms “advertisers” and “content providers” may be regarded as synonymous for purposes of the instant application.

The present invention provides, in certain embodiments, an integrated software that allows an advertiser or content creator to create an updateable page that pertains to the advertiser, but at the same time is personalized to a particular client user, for example, a consumer. This may preferably be integrated with a two-way software channel that uses the Internet or other network to exchange information between the client user and the Server. This server may be administered by a Server Administrator company or business, or an advertiser may administer such a server themselves.

In a preferred embodiment, the present invention provides for a client agent process that provides notification to a client user once new content has been delivered and stored on the client's hard drive and is ready for execution by the player (e.g., viewing). For example, an icon picture may be presented on the client machine desktop display, or an “alert” GUI button may be presented on the interface application to the Server Administrator and/or advertiser site. This button may be executed to play the newly loaded content. In an alternate embodiment, certain icon alert indications may inform the user of new content, which then may then start the transmission process for the new content. However, the content would not be available for viewing until the transmission was complete.

In a preferred embodiment, full digital control of multimedia playback is provided to the client user via an integrated player executable. For example, the client user may be provided with controls to Stop, Start, Zoom, or view a slow motion Replay. Preferably, when visual content is provided, a frame refresh rate of at least 34 Frames Per Second is applied, in order to provide a motion quality equal to or exceeding that of NTSC television.

In conjunction with the viewing and identification of specific product viewing, selected or viewed items may preferably be automatically written or stored to a shopping list stored locally or on the Server Administrator or advertiser/content provider server. This shopping list may be used by the client user either in a on-line transaction with the advertiser or content provider, or with a distributor or retailer of the same. Alternately, the client user may be given the option to print out the list for manual shopping at a physical retail location. This list may also be sent via SMTP or similar e-mail transmission to a physical store for fulfillment, to be picked up by the client user. Preferably, the recorded media device and central server can be integrated with an interactive two-way conduit of information, e.g. via CDF. In this manner, audio, video and graphics may be integrated in a manner that provides a multimedia experience to the client user while transferring information to and from the client. The information accessed by the client user, e.g., via execution of http links through the browser function of the present invention, allows for the mining of web information via a customized interface on the client's desktop.

When implemented for distribution via a CD/DVD physical media, the media may provide a for product identification and attendant delivery of appropriate e-commerce and content files.

### BRIEF DESCRIPTION OF THE DRAWINGS

The invention will be further described with respect to the Drawings, in which FIGS. 1-28 show representative views of a preferred application of this invention and in which like numbers refer to like parts throughout. The Figures are directed to a representative embodiment, in which music audio and video is available, together with graphics such as song lyrics.

FIG. 1 depicts typical data flows occurring in the course of executing a preferred embodiment of the present invention.

FIGS. 2-7 depict typical user interface screens that may be displayed in an implementation of the present invention.

FIGS. 8-22 depict typical user interface screens that may be displayed in an alternate implementation of the present invention.

FIG. 23 depicts data flows attendant to the integration on the client machine of forms of information.

FIG. 24 depicts the sequence of interfaces displayed upon installation and execution of an executable according to an embodiment of the present invention.

FIGS. 24a-c depict detail of the sequence of interfaces displayed according to FIG. 24.

FIGS. 25a-l depict a series of user interfaces according to the execution of one implementation of the subject invention.

FIGS. 26a-i depict a series of user interfaces according to the execution of an alternate implementation of the subject invention.

FIG. 27 depicts a suitable class implementation of the OSD aspect of the invention.

FIG. 28 depicts a suitable class implementation of the CSF aspect of the invention.

### DETAILED DESCRIPTION

A network application or system implemented according to the present invention will offer almost instantaneous global availability of high-quality audio & video, that may feature the message of the advertiser or other content provider. This network foundation will preferably provide updates for research, products, prices, inventory, regulatory changes, etc.

In a preferred embodiment of the present invention, the Server Administrator may derive revenue from the services it provides to advertisers and content providers. These revenues may, for example, take the form of fees for development, transmission of content, a royalty based on the number of client user/consumer sales derived from the service, or fees for the provision or analysis of data mining and targeted consumer preference information.

In addition to consumer sector applications, the present invention may be applied in fields with client users who are not retail or end-consumers. For example, the present invention admits of application to supply-chain management & maintenance, update and alerting regarding product specification changes, availability, and wholesale pricing, update and educate health care professionals regarding new medications or treatment modalities, the provision of content for advertising agencies on behalf of their clients, or any other application that may benefit from a pseudo-broadcast network with defined demographics. As further examples, a university may broadcast general information, fund raising, special events and educational curriculum. Intra-company business communications may provide video and audio updates to internal catalogs, pricing, etc., or provide a specialized corporate retirement broadcast network.

The installation of the broadcast code according to the present invention causes the advertiser's content to become centrally integrated with the consumer's desktop and embeds a permanent, interactive connection to the desktop of the consumer. This provides a very inexpensive, direct means of communicating very large amounts of data and high-quality information to consumers at extremely low, relative prices compared to comparable direct marketing methods.

The present invention provides for a data transmission system that uses bandwidth throttling to avoid interference with simultaneous data transmissions effected by the client user, thus making the transmission transparent to the client user. Also provided is a system of transmission retry in the event that a download connection is not established, provision for partial file request by the client user, and partial delivery. In addition, in a preferred embodiment, the integrity of the transmitted data is confirmed using a CRC process or similar checksum procedure.

In a preferred embodiment, a system according to the present invention is based on downloading, rather than streaming, as streaming may be subject to certain network or transmission capability limitations. However, the broadcast system according to the present invention also admits of streaming in networks having sufficient bandwidth. In networks in which streaming is not plausible, the download methodology of the present invention may be expected to ensure delivery and quality of results.

For example, a broadcasted video of a new fashion runway show can be transparently integrated with a catalog, beauty-tip utility or data, and other new product information for much less money than shipping video cassettes and distributing expensive, glossy catalogs through the mail. Once the consumer is prompted to download the Server Administrator broadcast utility, the advertiser, which may be a customer or licensee of the Server Administrator, establishes a resilient, interactive communication capability with the consumer. This channel can be exploited to maximum efficiency and provide instantaneous feedback, data-mining and demographics, as well as increased consumer or purchaser satisfaction.

As a further aspect of this information exchange, the present invention preferably allows the client user to customize his or her selection of information he/she might like to receive in the future. This creates a further data-mining opportunity and ability to continually provide the targeted audience with appropriate information.

While the download time will vary, depending on the quality and length of the transmission, the client user is not penalized using the system of the present invention to implement downloading. The download happens in the background, the client user being free to execute other processes on the local machine. Preferably, when the broadcast is finished downloading, an activation icon may be presented at the client user GUI, which may be executed by the client user to view the content.

According to a preferred embodiment of the invention, the Server Administrator may use MPEG-4 technology to dramatically reduce download times to approximately ¼ that of MPEG-2. Broadcasting through a high speed network will require between 50 minutes to 3 hours to download a 30 minute video over a high-speed line (depending on the type of broadcast quality) and from 8½ hours to 31 hours to download it fully onto a 28.8 k modem.

Preferably, a Server Administrator practicing the present invention will use a very high quality of transmission which will provide media above television quality and can be as good as a DVD. The speed of the typical download time for one minute of video using this transmission quality will range from approximately 24 minutes using a 28.8 modem, and only 2 minutes using a high-speed cable modem.

During the time that media is being sent to a client computer, the computers must be online, i.e., connected to the Internet. In the event that this connection is interrupted, the present invention preferably provides for automatic resumption of the media download process, as opposed to beginning the download again. The use of controlled downloading as opposed to streaming prevents multiple, simultaneous demands on, and resultant overtaxing of, a company's server capacity. This has been widely publicized in the press when too many people want to view broadcasts from a server farm at one time. Controlled downloading according to the present invention allows the Server Administrator to completely control the sequence, timing and amount of downloading in accordance with the Administrator's computing and bandwidth infrastructure. Additionally, downloading allows the Server Administrator the ability to improve the quality of delivered media by compressing the video or audio content to provide for full-screen, high-quality viewing on a PC. According to the present invention, the Server Administrator is able to transmit a byte-for-byte transmission which is filly assembled on the consumer's hard drive prior to a live broadcast. While the time required to complete the transmission varies by connection speed, low-bandwidth client users are not precluded from a quality transmission.

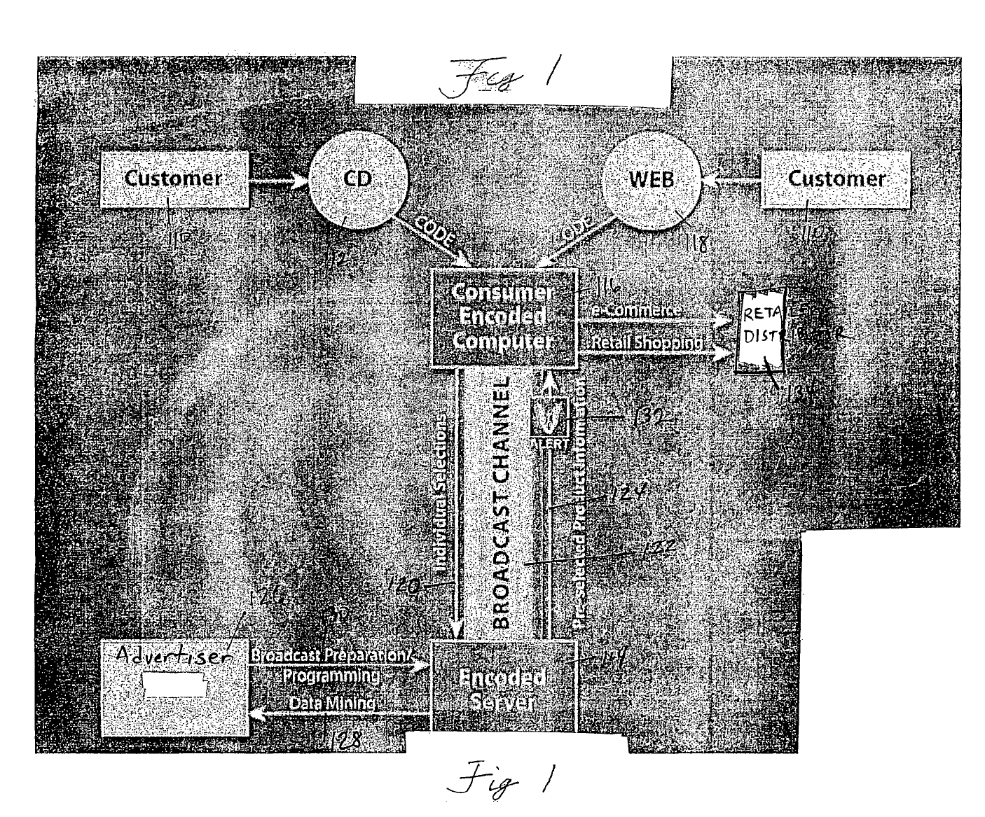

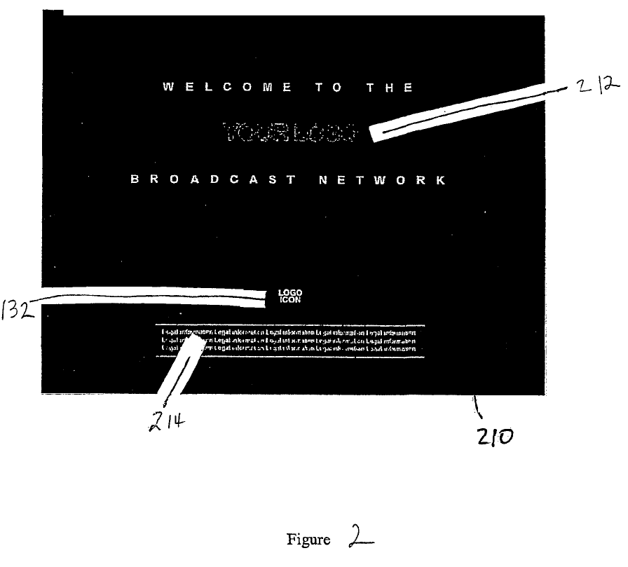

FIG. 1 depicts typical data flows occurring in the course of executing a preferred embodiment of the present invention. Customer or client user 110 loads CD 112 having executable content supplied by administrator of Server 114 or advertiser into client machine 116. Alternatively, executable code may be loaded into client machine 116 via download from Internet or “Web” at 118. Selections and preferences 120 of user of client machine 116 are supplied over a data channel 122 to server 114. Responsive product information 124 that may interest the user of client machine 116 is supplied via data channel 122 as well. Preference information 120 may also be made available, in the aggregate across a plurality of client users, to Advertiser entity 126 as data mining stream 128. Advertiser or other content producer 126 may in turn supply responsive programming or media 130 presentations to server 114 for loading onto remote client machine 116. This media content may make up all or part of data flow 124 to client machine 116. When media content has been loaded to the client machine 116, the client may preferably be notified via icon 132 to be displayed at the client machine interface (not depicted). Individual information 120 and selected information 124 may take the form of an interactive shopping list that may be transmitted or brought to retailer/distributor 134 for fulfillment. Advertiser 126 may also administer and operate server 114 and retailer 134 directly.

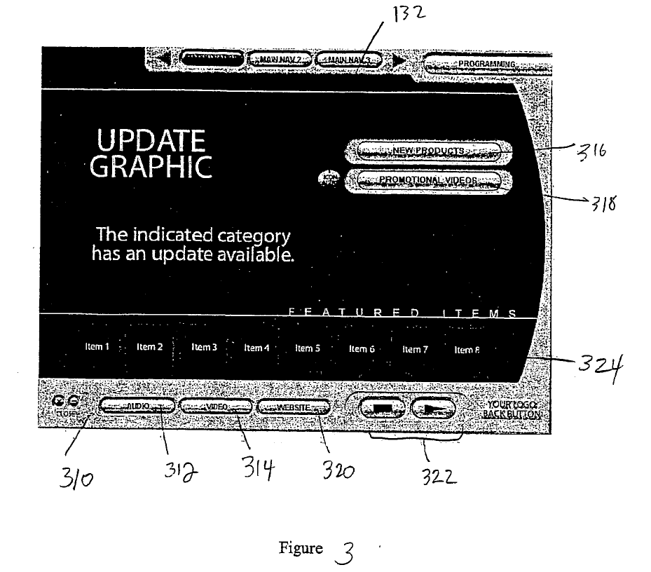

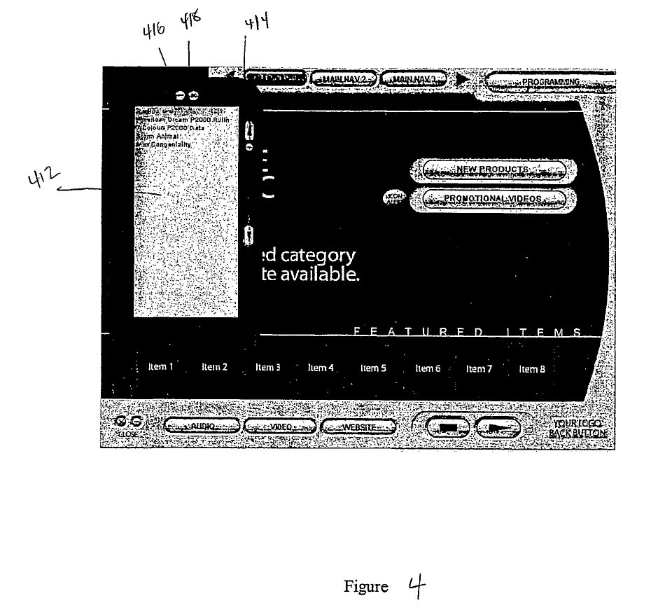

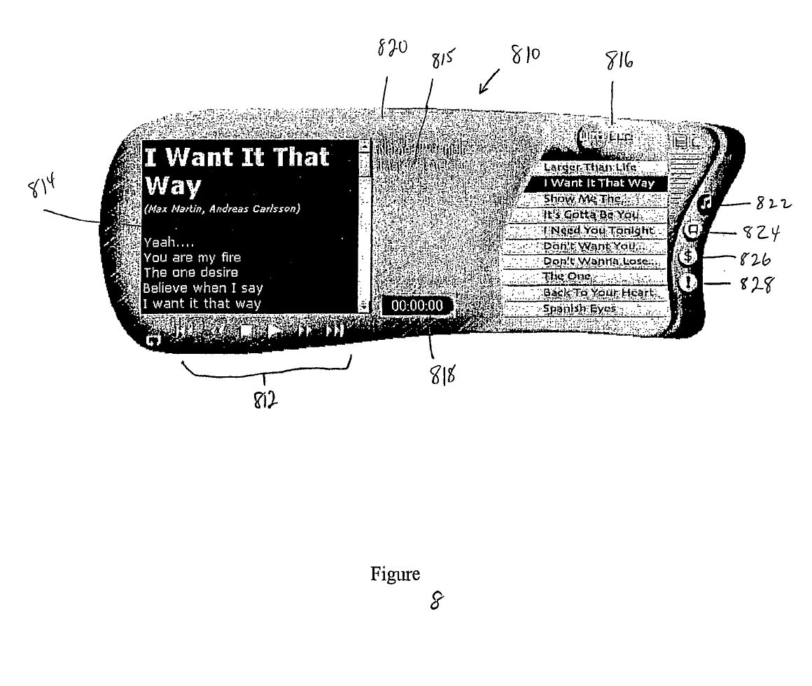

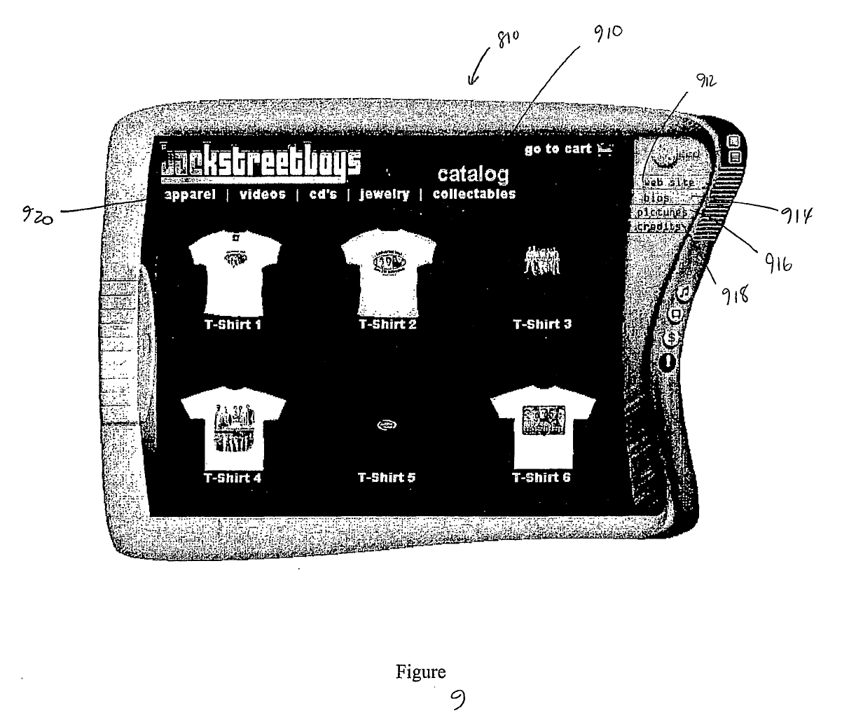

FIGS. 2-7 depict typical user interface screens that may be displayed in an implementation of the present invention at client machine 116 of FIG. 1. FIG. 2 shows a suitable introductory screen 210. This intro screen 210 may display the logo 212 of advertiser 126 of FIG. 1, as well as a suitable advertiser or other alert logo or icon 132 that will be displayed upon the arrival of updated content. Legal information 214 or terms and conditions may also be displayed. FIG. 3 depicts a further interface 310, showing different types of multimedia that may be updated at client machine 116. For example, client machine 116 may display a video menu via GUI button 312, audio menu via GUI button 314, and subscribe to new product information or promotional multimedia presentations via GUI buttons 316 and 318 respectively. If new content is available in one of these categories, the user of client machine 116 may be notified via icon alert GUI button or display 132. Http data may be displayed via GUI button 320, and multimedia content may be controlled via control GUI elements 322. Executable GUI elements 324 may display thumbnail images depicting multimedia content for execution and playback. As depicted in FIG. 4, upon execution of video GUI button 312, video menu 412 may be displayed, with menu navigation control 414. This menu may be minimized or closed via execution of GUI buttons 416 and 418, respectively. Similarly, execution, or cursor “pressing” of GUI button 314 may display audio menu 512 with menu navigation scroll 514 and minimize/close buttons 516 and 518. As shown in FIG. 6, upon execution of programming button 612, GUI elements 614 may be displayed showing various forms of information or multimedia content that may be subscribed to that may be pushed to the client machine 116 via channel 122. After election of one or more types of information 116, with selection indicator GUI light or selection button 616, confirm GUI button 618 may be executed, sending selections to server 114. An depiction of a multimedia selection interface is depicted in FIG. 7.

According to a further embodiment of the subject invention, an application is provided that seamlessly integrates audio, video and/or graphics with a system of Broadcast that allows for two-way interactivity between the Server Administrator Marketing Client and its client user customer.

The user interface provides for a similar “look and feel” for the user, but also allows the user to access and display information from a variety of sources, including local media (e.g. hard drive or digital media) and web-based online content, including dedicated integrated servers, affiliated servers or even other computer users (e.g. peer-to-peer). This is an important element in the overall capability of the company because as the Broadcast Network expands, consumers will demand and need an easy-to-use system for accessing their programs.

The remote client code according to the present invention can be delivered via a physical tangible recorded medium (chips, disks, etc.) or downloaded online. In a preferred embodiment, the application is provided in a form where it is recorded on, and combined with, digitally recorded content, such as a music CD or DVD.

The present invention is preferably implemented in a manner to provide a utility by which consumers control their library of videos or other content as follows. For those PCs that are on the fringe of being able to use the technology, particularly for those client machines with storage space that is less than that offered with state-of-the-art computers, a client program according to the present invention preferably offers personalization settings for degrading video quality and selecting how many videos can be stored on the user's system. The user also is given complete control over editing, deleting and updating their media library within local storage to ensure capacity is used efficiently. Broadcasts by the Server Administrator may be expected to require local (client) storage space as follows: A 30 second commercial will require 10 Megabytes of storage capacity, or approximately 0.04% of the hard drive of a typical current PC. Likewise, a 5 minute music video will require 100 Megabytes of storage capacity, or approximately 0.5% or the drive, and a 30 minute video will require 600 Megabytes of storage capacity, or 2.8% of the capacity of a typical hard drive.

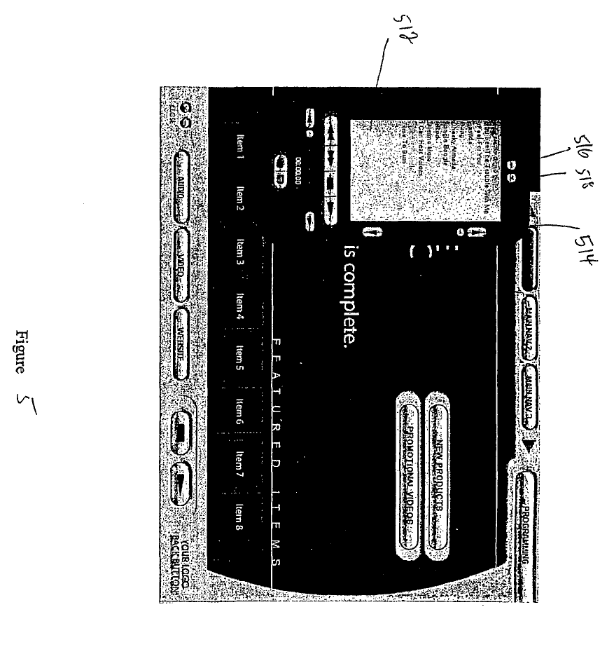

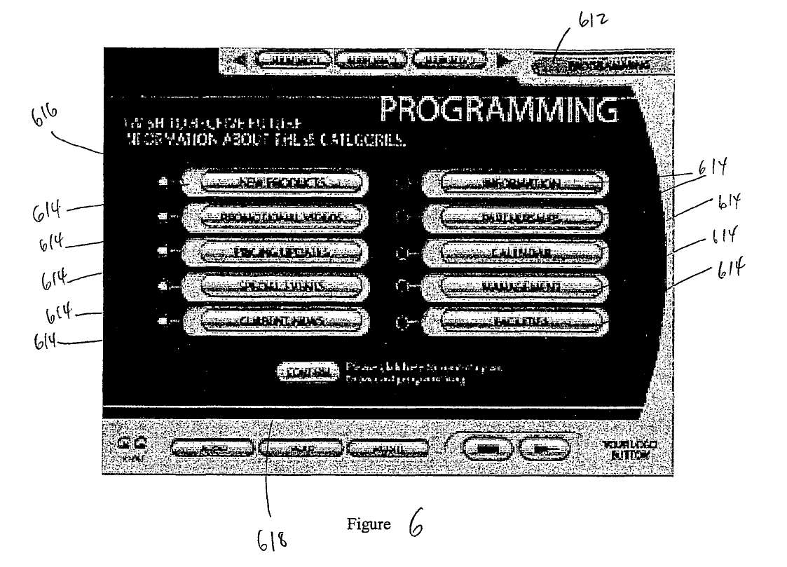

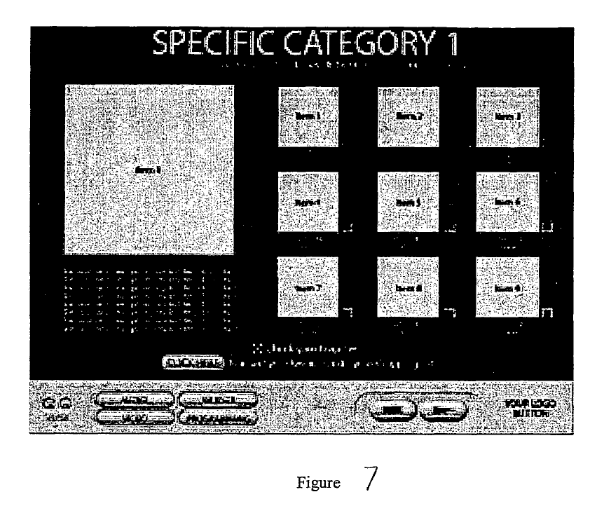

Computers shipped before 1998 may have capacity issues for larger downloads, unless the user carefully accommodates the Server Administrator broadcast download. Regardless, preferably the present invention interface will affirmatively present the user with the choice of keeping, or deleting any transmissions received. In this way, capacity issues that affect computer functioning, such as insufficient swap or cache space, are avoided. In a preferred embodiment, the provider of the broadcast delivers to the consumer an application with a GUI “tool kit” to delete, edit, review and store the information broadcast to them, as depicted in FIGS. 4 and 5, above.

Because broadcasts according to the present invention are delivered in a manner that is similar to SMTP or http traffic over the World Wide Web, it is possible for firewalls to inhibit its delivery system. Broadcasts according to the present invention, like any web site transmissions may be received, screened and monitored. However, in a preferred embodiment, broadcasts will circumvent web site monitoring by using secured channels that are not typically monitored or blocked by ISPs or businesses. Because the client user, with minimal or no effort, will have access to a broad range of content, it will be preferable to provide rich customization and broadcast tools to the Server Administrator, allowing the client to parse through and personalize all the information received. As mentioned, broadband will reduce download times dramatically thus, it will make users of the Server Administrator broadcast technology.

Preferably, the remote client interface is branded in accordance with the identity of the advertiser, e.g., the customer or client of the Server Administrator, i.e., a company-controlled broadcast channel is provided, and thereby installing a permanent interactive communication with pre-selected customers. Because, in one embodiment, the present invention alerts pre-selected customers via executable GUI icons, or “activation icons” pushed to the client application with fully loaded new content, e.g., news about products as specified by the client user, this may be expected to lead to or encourage shopping activity where so designed. This marketing activity, being permission-based as it is, may be expected to have increased efficiency over traditional marketing methods. The viewing of updated product information may preferably be coupled with shopping list creation and attendant discount offers.

The present invention thus provides a transparent mode of operation between CDs, hard drives and servers, and allows the movement of huge files over the Internet over time for immediate playback with TV quality. In this manner, the present invention brings what may be considered a pseudo broadband to a larger market.

According to one embodiment of the present invention, a CD, DVD, or other optical or magnetic media may be mailed via surface mail as a direct marketing tool to an audience selected according to traditional marketing demographics systems and criteria. This physical media thus is used to replace or at least supplement other printed materials. The CD or DVD may include music, product videos, product descriptions, and a broadcast code that may, in one embodiment of the invention, be written to the user's hard drive on their local machine. The marketing channel is thus opened. The user is given an incentive to install the CD onto their PC perhaps by means of media of a popular entertainment group, or game or other digital content. Over time, the present invention may be expected to establish a resilient two-way relationship with customers such as consumers. Information about products and services is provided in a TV-quality manner, and future categories for information transmittal may be selected by the client user or the client user's institution. Upon completion of transmission, a new transmission may be executed by the selection of an icon alerting the client user of completion. Preferably, no time delay is experienced by the client user between the time that an icon alerts him to new content, and the time that this content is available for viewing. In contrast to streaming multimedia systems of the prior art, a marketing and/or entertainment channel implemented according to the present invention is not dependent on the remote user enjoying the use of a broadband-caliber connection. Instead, a two-way channel of communication is set up between the Server Administrator and the client user. In addition to the flow of information, such as advertising information, to the client user, there is also a data-mining flow of information that may be provided back to the Server Administrator, which may be organized and analyzed by the Server Administrator for presentation to the advertiser, or the data may be supplied in raw form for analysis by the advertiser. In this latter embodiment, preferably the Server Administrator does not provide services to advertisers in competitive fields.

Because, at the time of icon activation notifying the user of content, the data making up the content is resident on the local client machine, manipulation of the content is possible that is not possible with streamed media content, e.g., freeze-frame, zoom, playback, review and fast-forward.

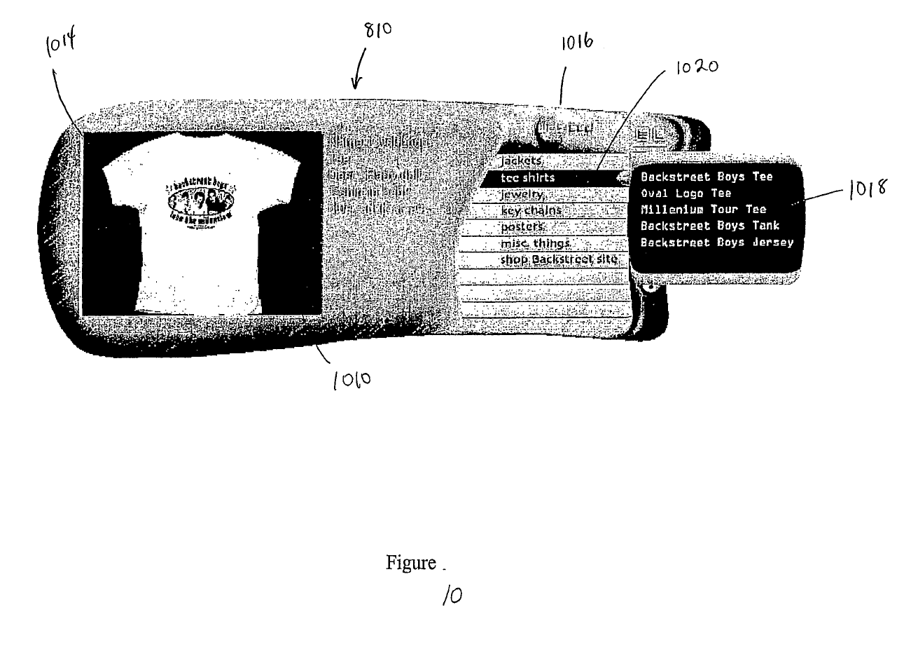

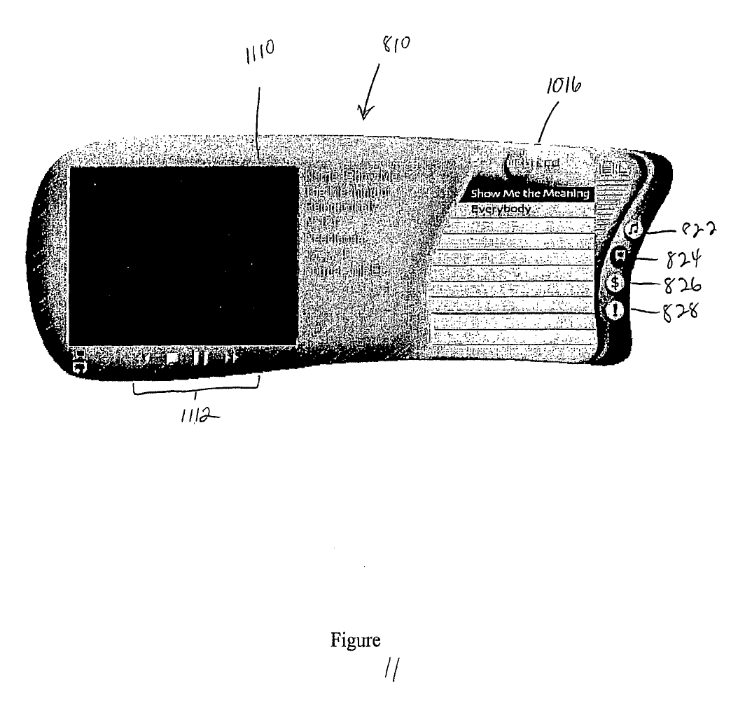

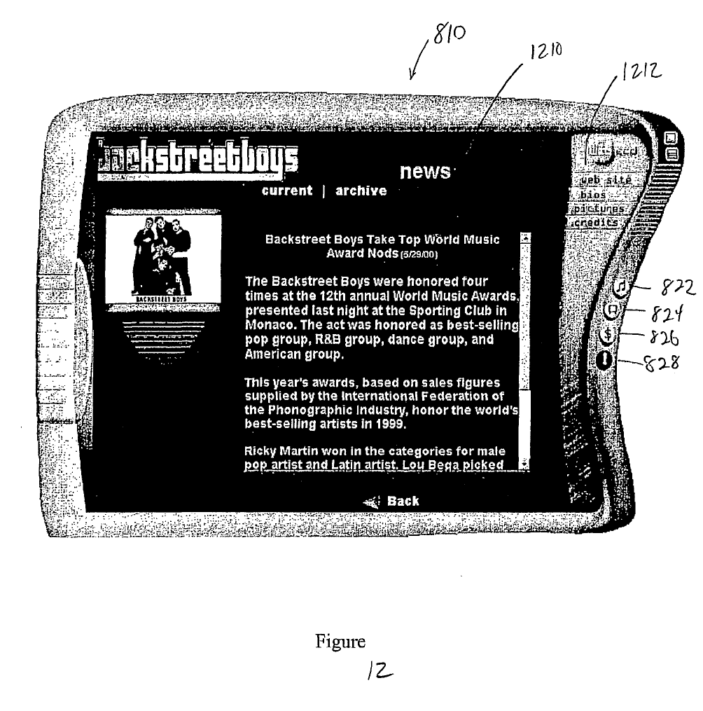

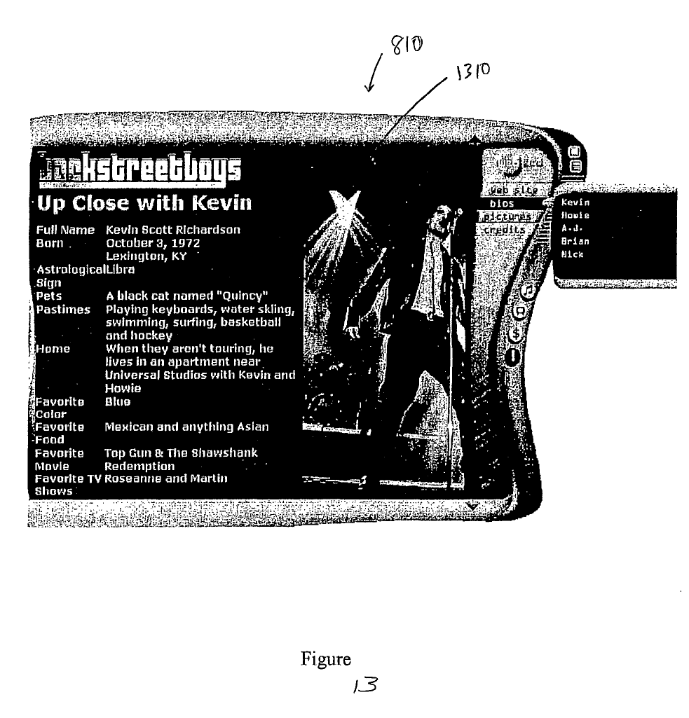

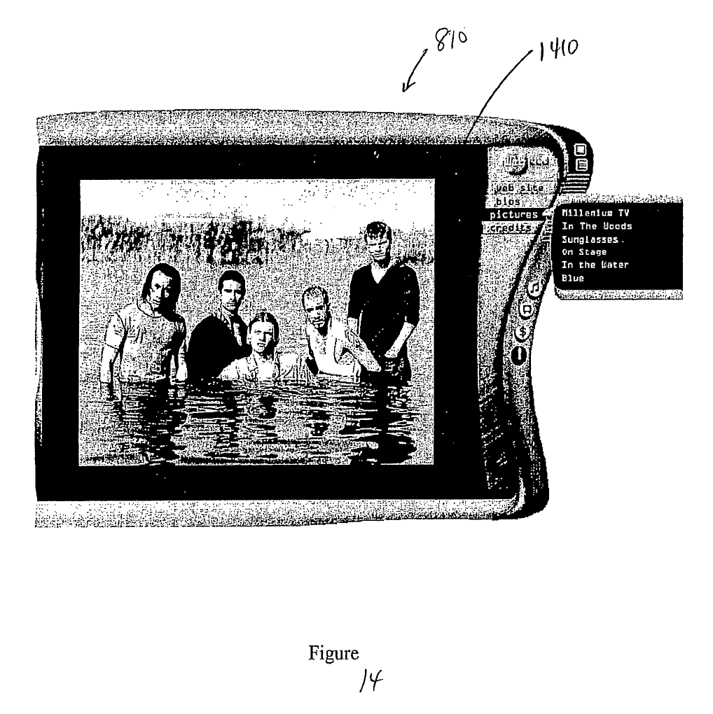

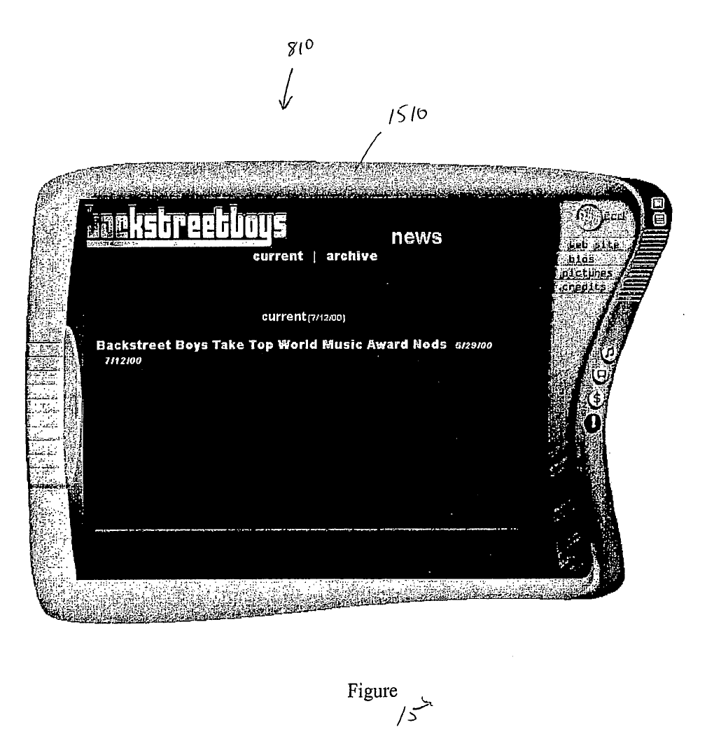

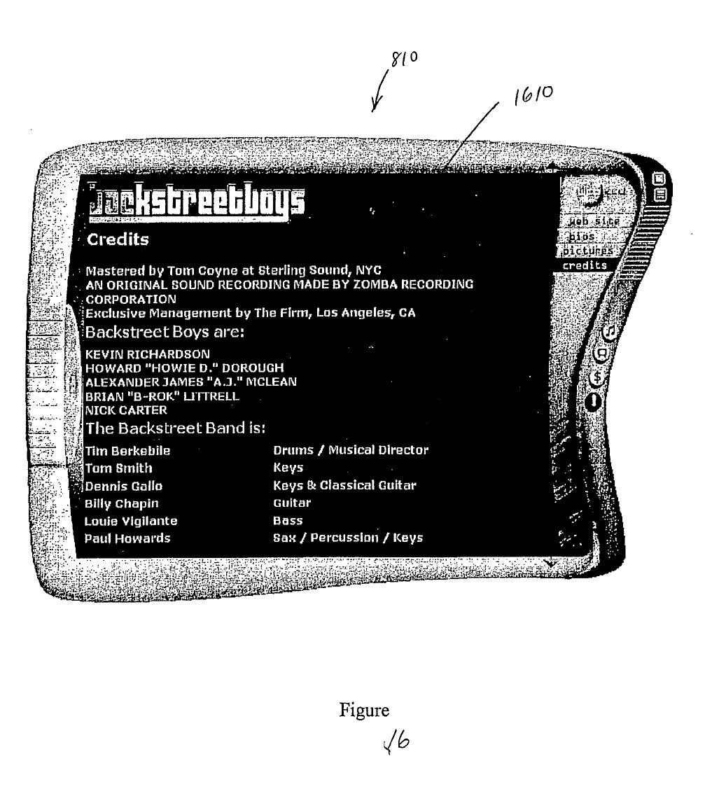

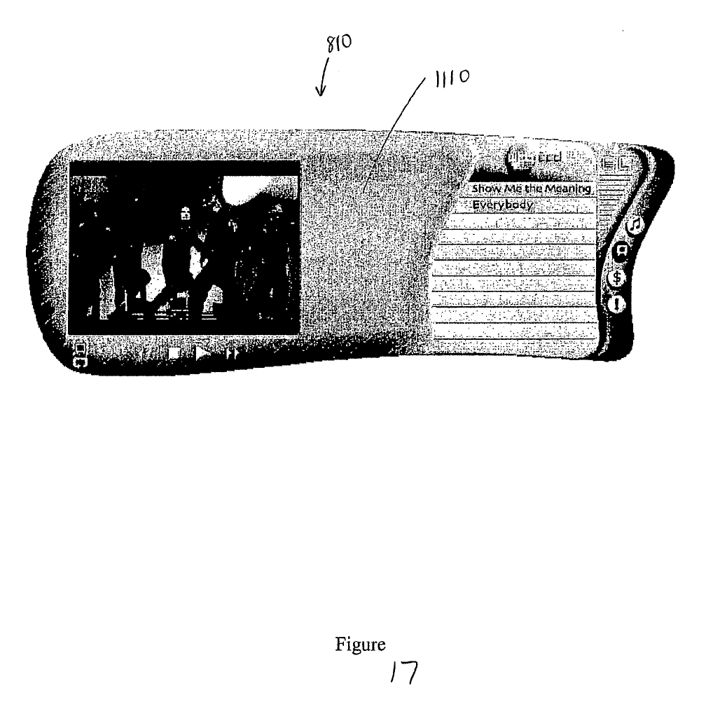

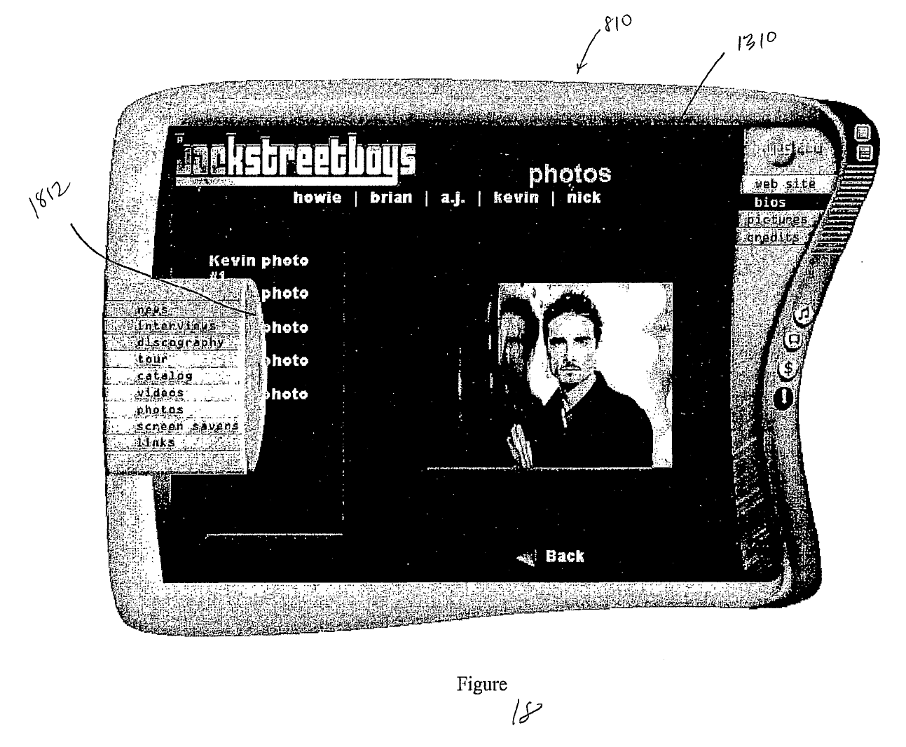

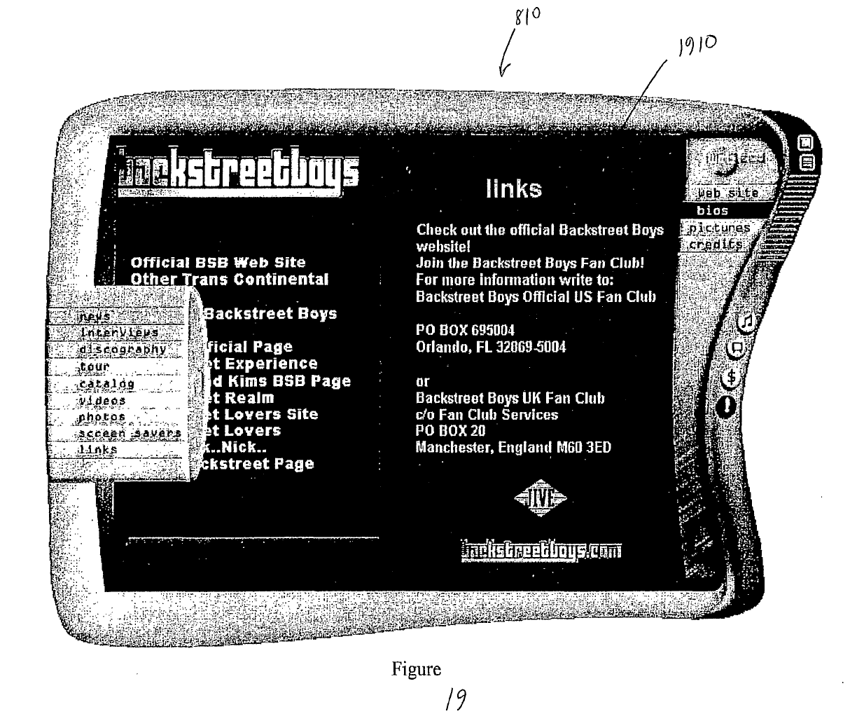

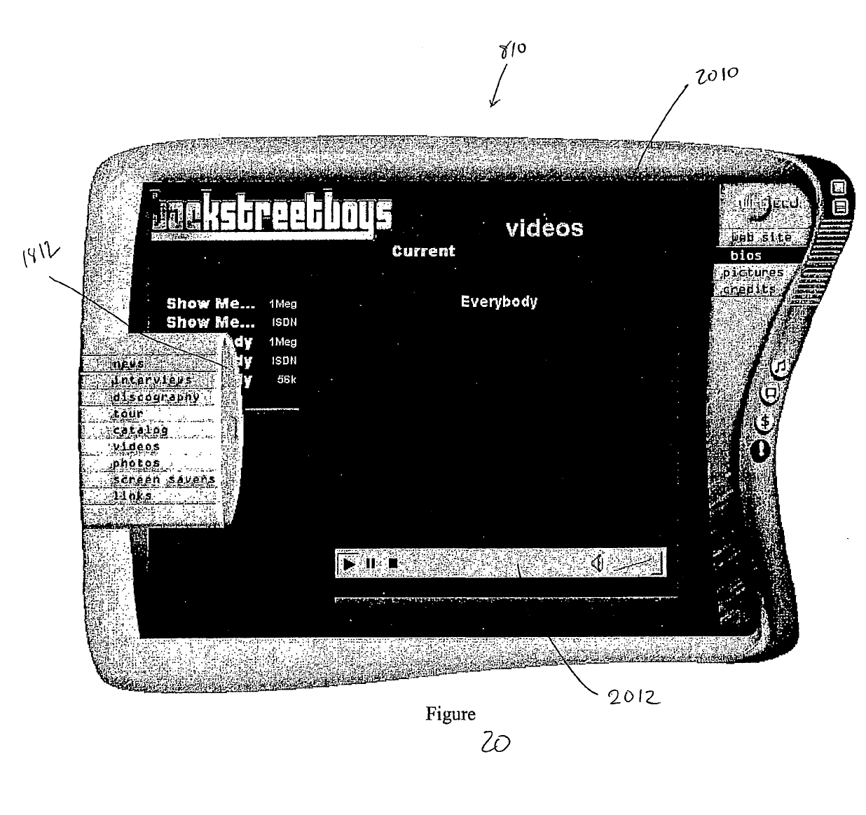

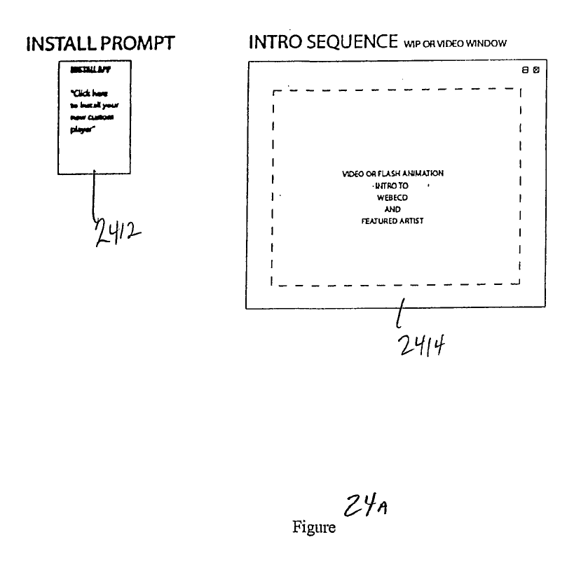

FIGS. 8-22 depict typical user interface screens that may be displayed in an alternate implementation of the present invention. According to this embodiment, a CD may have encoded within the data displayed, or this data may be accessed via a public network such as the Internet. In FIG. 8, a player interface 810 is provided, with audio controls 812, lyric and composer information display 814, current track data 815, and CD track selector 816. Elapsed time may be indicated via display element 818. Track selector 816 may be “slid into” GUI display 820, for example, to conserve desktop space or neaten the GUI environment of the player interface 810. GUI buttons may be provided for linking to the audio content (displayed in FIG. 8) via GUI button 822, video content button 824, merchandising content 826, and news content 828. A suitable GUI display 910 of a website type, responsive to execution of GUI merchandising button 826 is depicted in FIG. 9. Branching may occur from this display 910, for example, to website content via GUI press bar 912, biographical information regarding a recording group via pressbar 914, still photographs via pressbar 916, and content credits via pressbar 918. Other merchandise types may be accessed via executable links 920. An alternate GUI interface for merchandising display integrated with media interface 810 of FIG. 8 is shown in FIG. 10, with merchandise types 1016 substituted for track information, and submerchandise information in pull-down menu 1018 from merchandise type selection bar 1020. Graphic display 1014 may display appearance of merchandise selected from pulldown 1018. Upon execution of video GUI button 824, the Video interface 1110 may be displayed, with interface components corresponding to that of audio interface 810, notably video selection interface 1016 and video playback controls 1112. Similarly, news GUI button 828 may display news in a similar player interface 1210 shown in FIG. 12, with linking elements 1212 to bio information as depicted in GUI interface 1310 of FIG. 13, or pictoral content interface 1410 of FIG. 14. News links may also be provided from integrated interface 810 via news interface 1510, as well as content production credits via credits interface 1610.

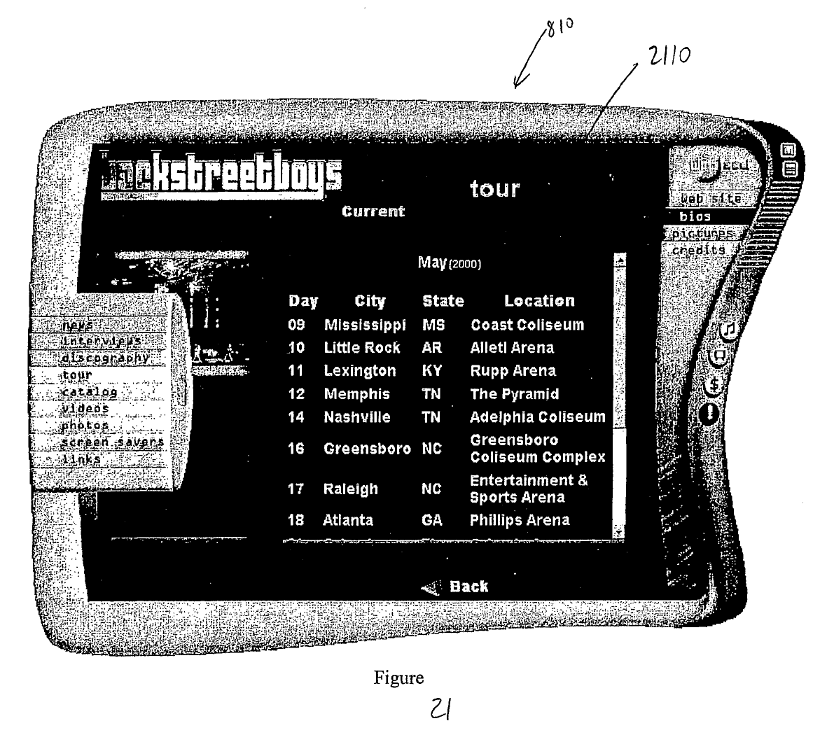

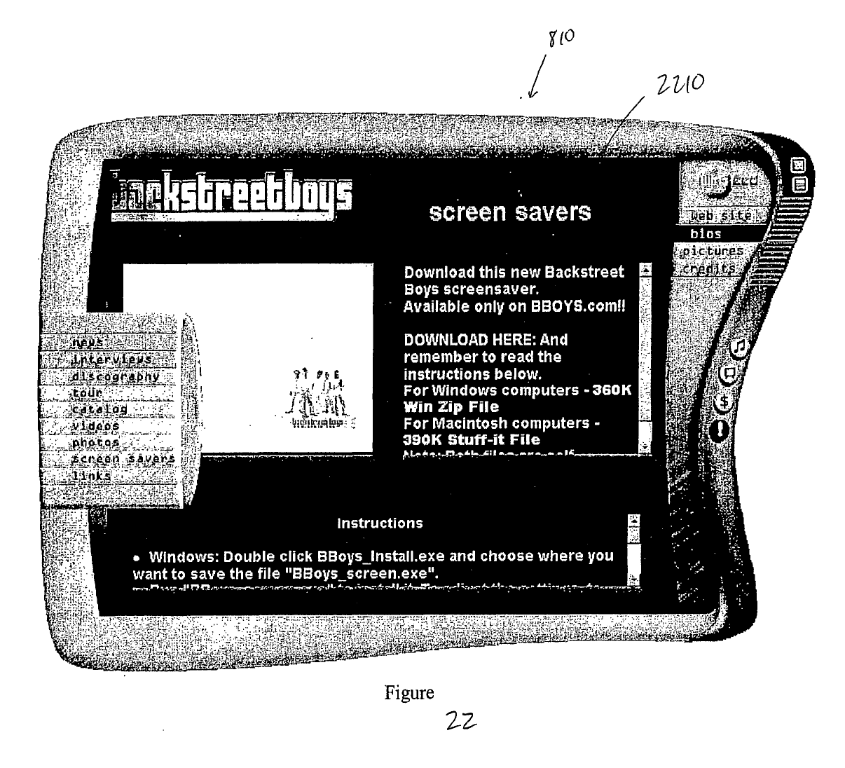

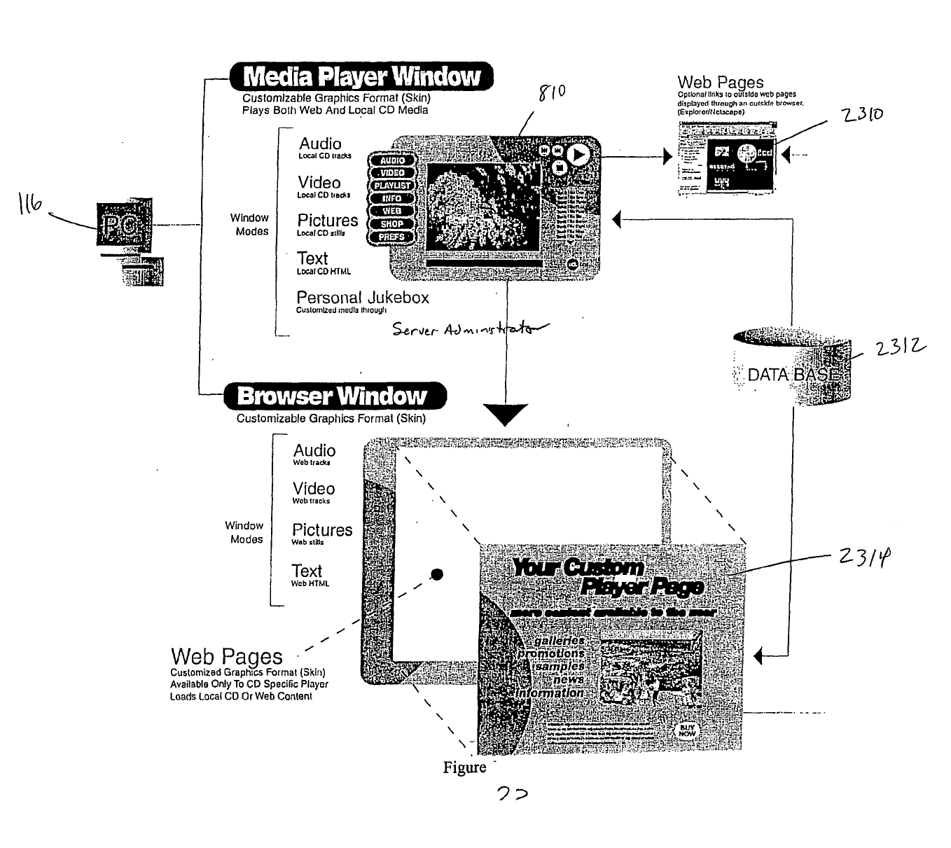

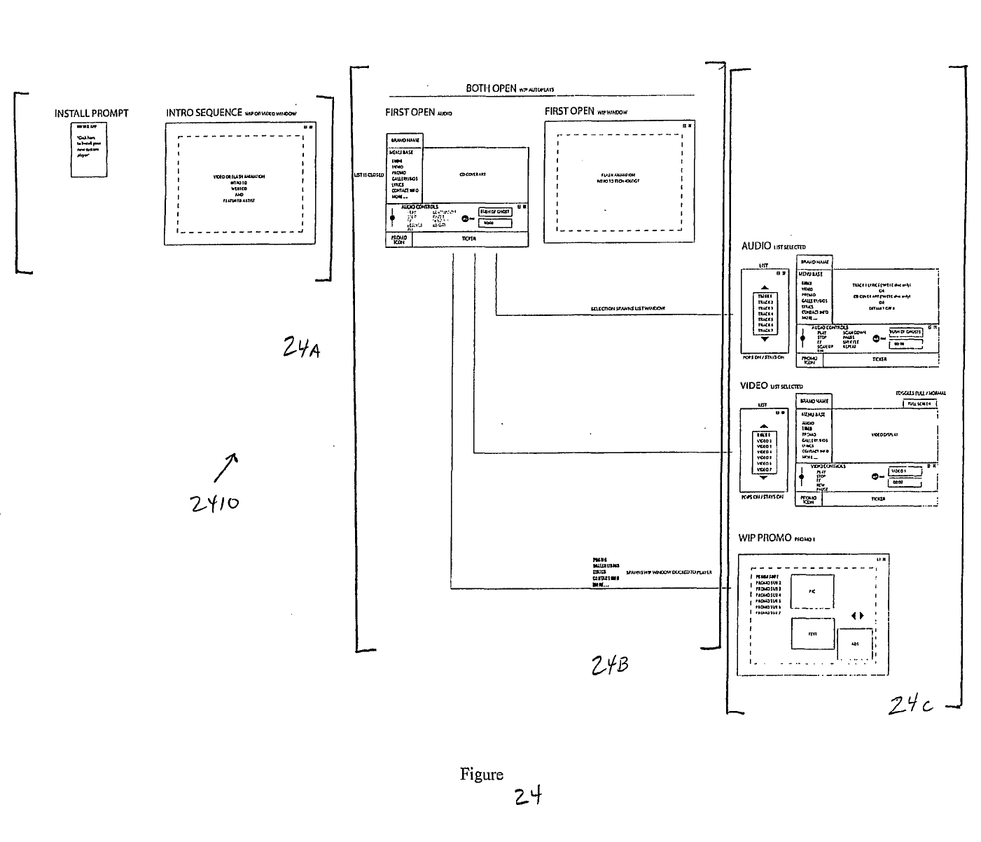

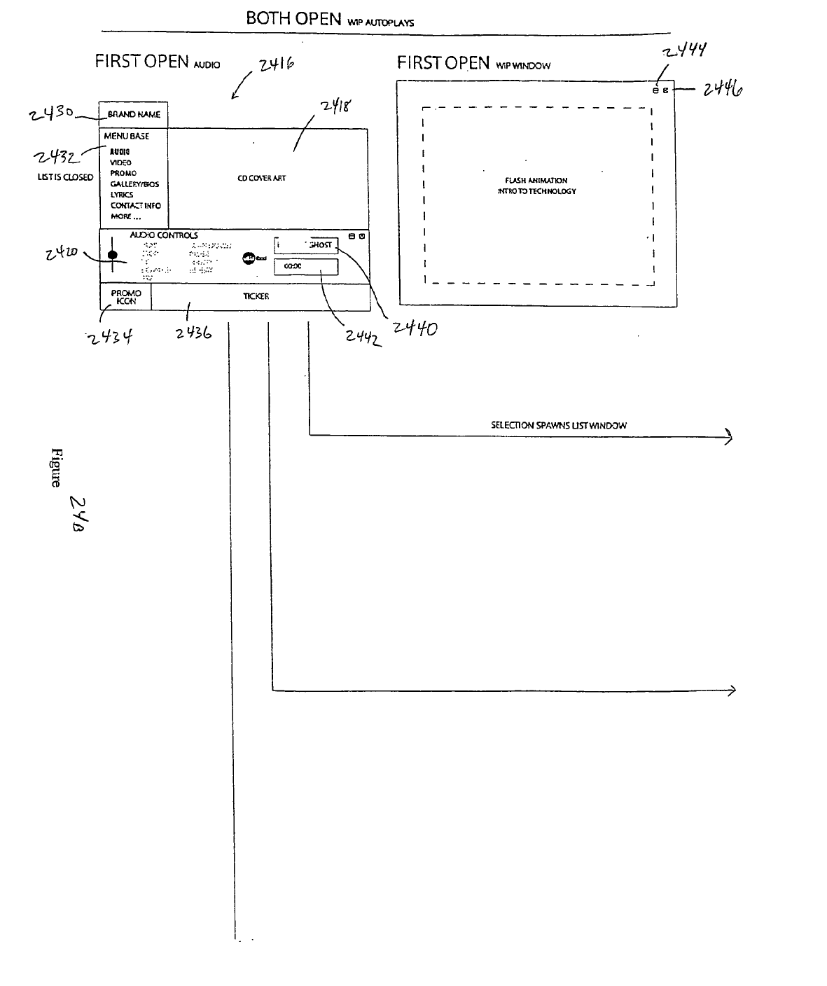

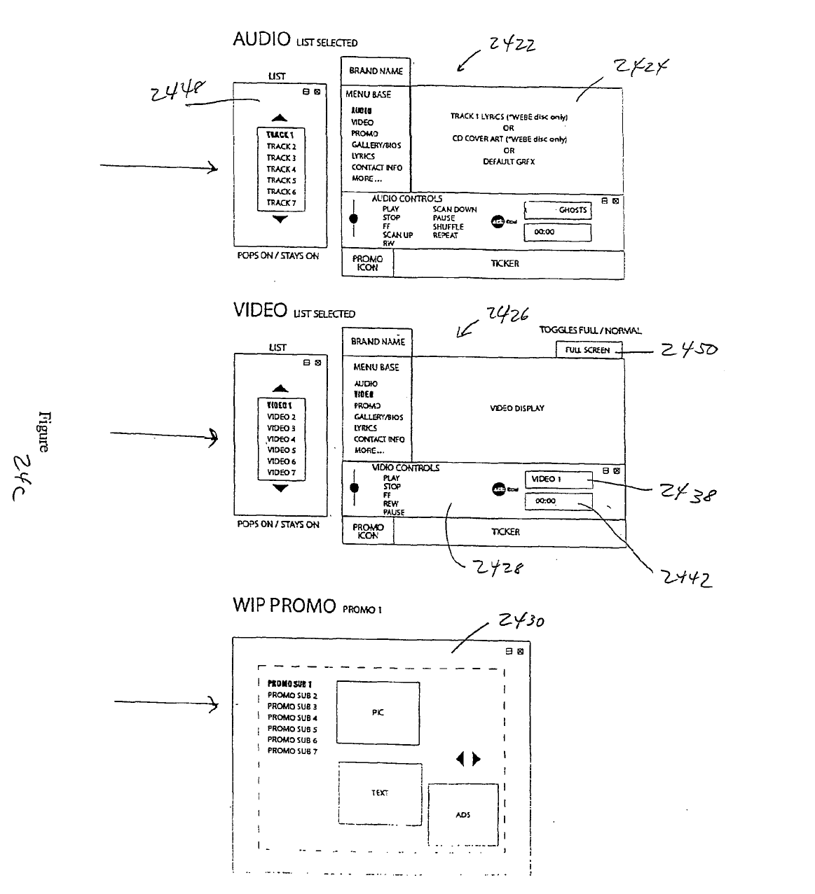

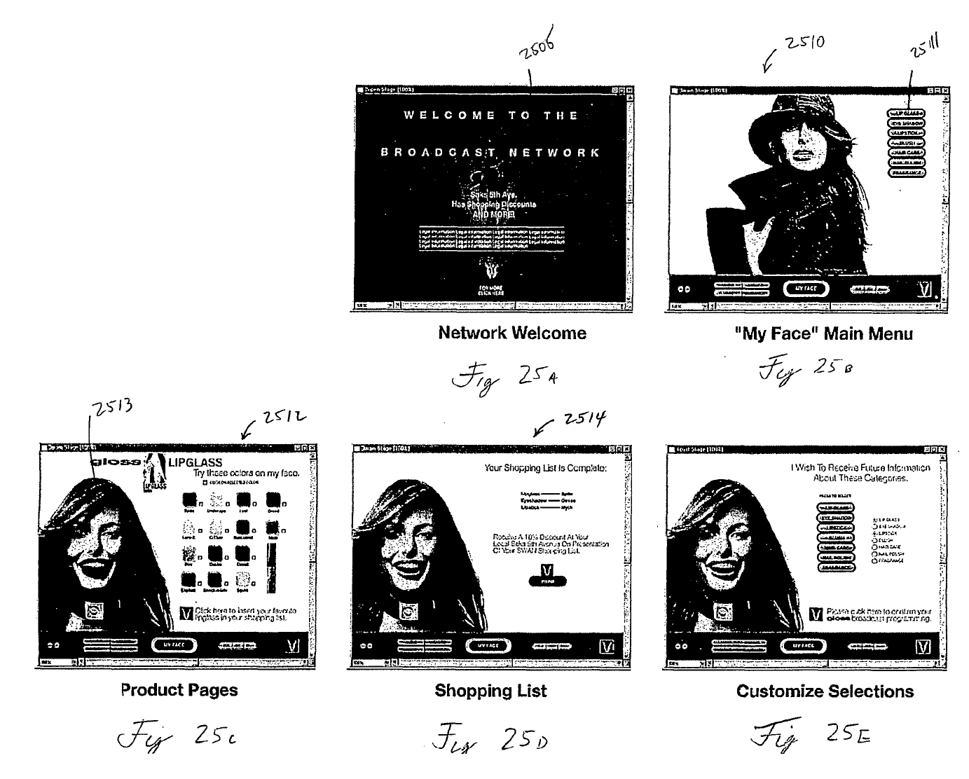

Execution of video interface 1110 is further depicted in FIG. 17. Further biographical content is shown via bio interface 1310 in FIG. 18, selected for example via pull-out GUI menu 1812. Linking information may be provided via links interface 1910 of FIG. 19. Web based content, for example, streaming content, may be displayed via selection from pull-out menu 1812 and viewed in web video interface 2010, featuring video control GUI element 2012. Other news such as tour dates may be shown in news interface 2110 as shown in FIG. 21, selectable via pull-out menu 1812. Other downloadable content, e.g., screen savers, may also be provided via download interface 2210 shown in FIG. 22.

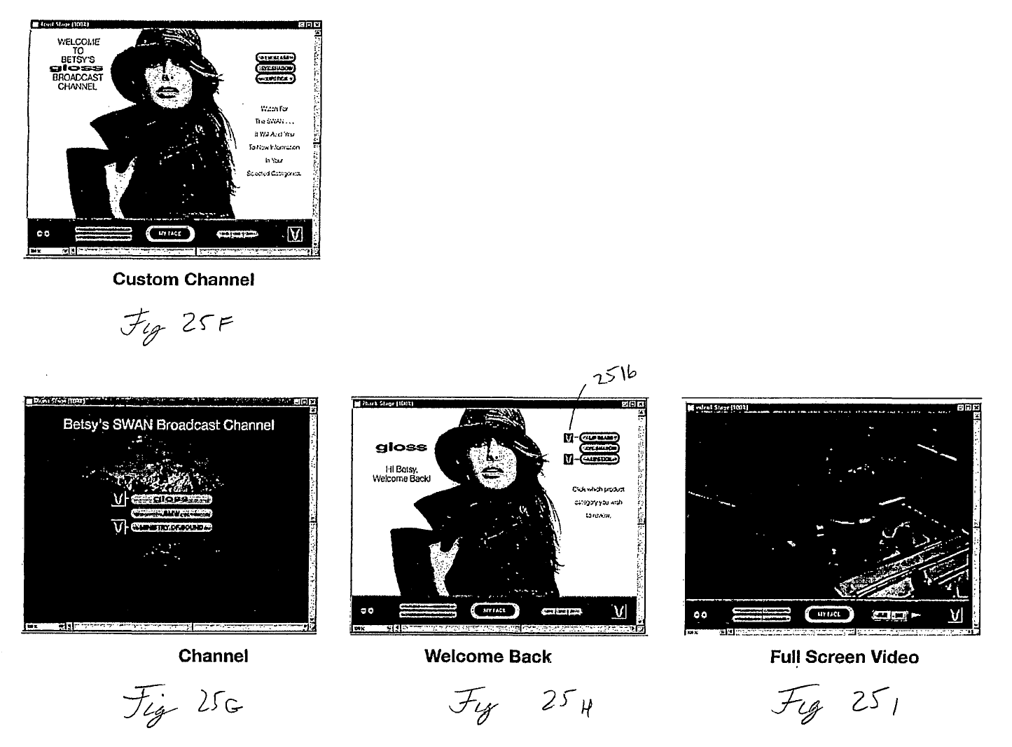

FIG. 23 depicts data flows attendant to the integration on the client machine of forms of information according to an embodiment of the present invention. Client machine 116 is shown having loaded thereon GUI elements 810 and displaying thereon web and downloadable content 2310. The downloadable content selected by the user of client machine 116 may be stored within database 2312 for supplying to advertiser 126 of FIG. 1. The information stored within database 2312 may also be used to update a custom player 810 that will be attractive and relevant to the user of client machine 116. A custom browser may also be informed by client machine user selections (dataflow 120 of FIG. 1) in order to provide a relevant web browser 2314 having player functions within.

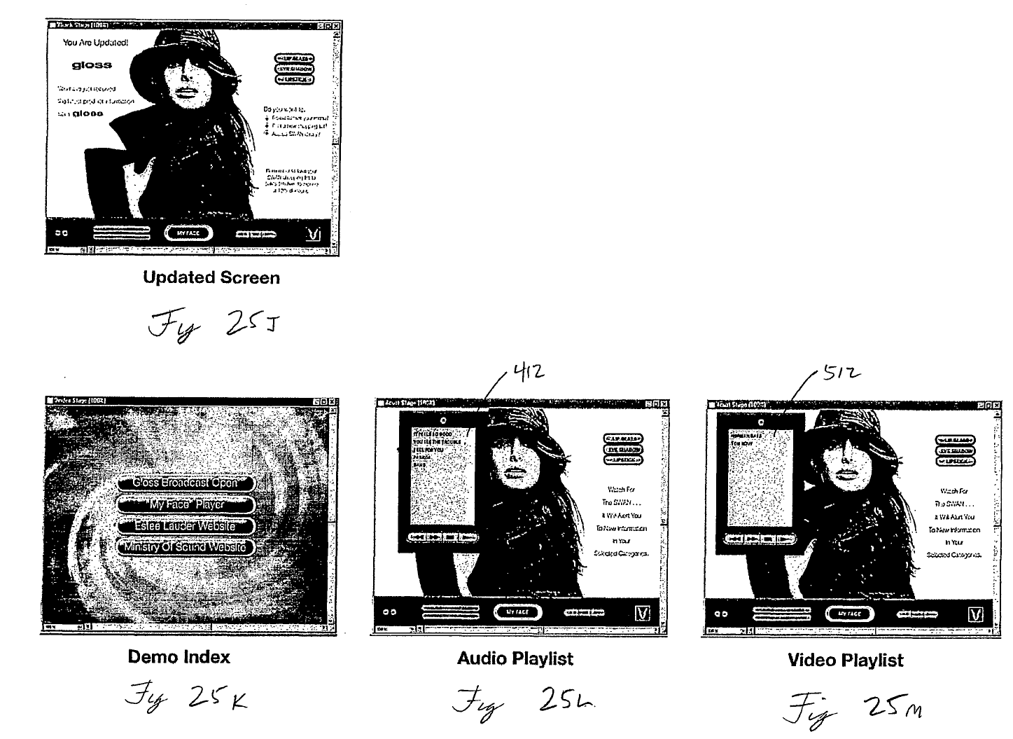

FIG. 24 depicts at 2410 the sequence of interfaces displayed upon installation and execution of an executable according to an embodiment of the present invention. As shown in FIG. 24A, an install and introduction may be displayed at 2412 and 2414, respectively.

FIGS. 24a-c depict detail of the sequence of interfaces displayed according to FIG. 24.

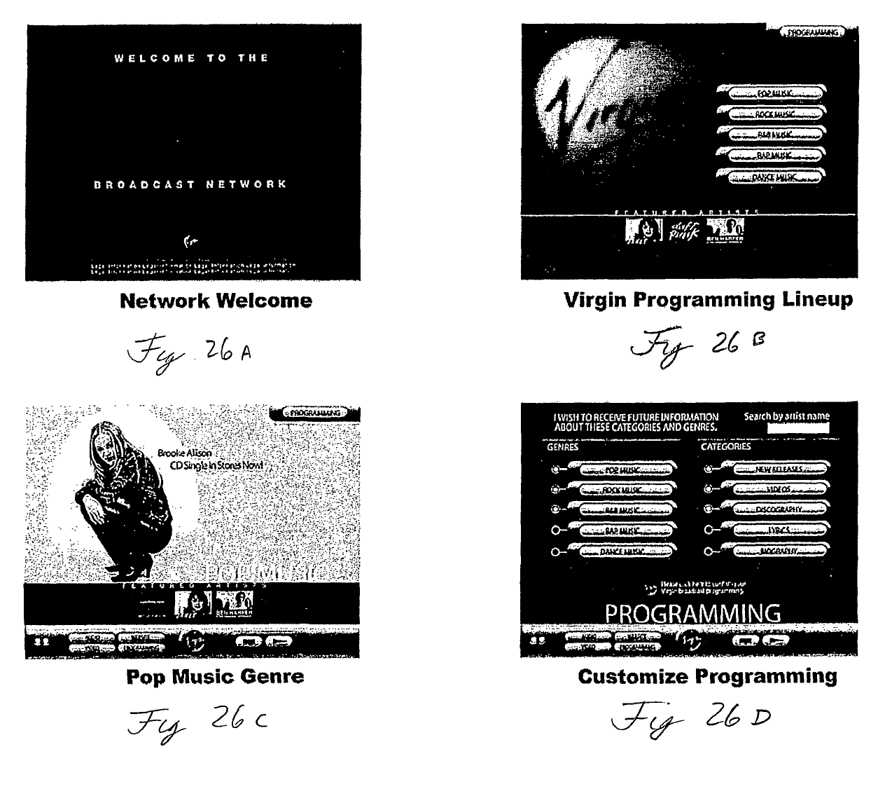

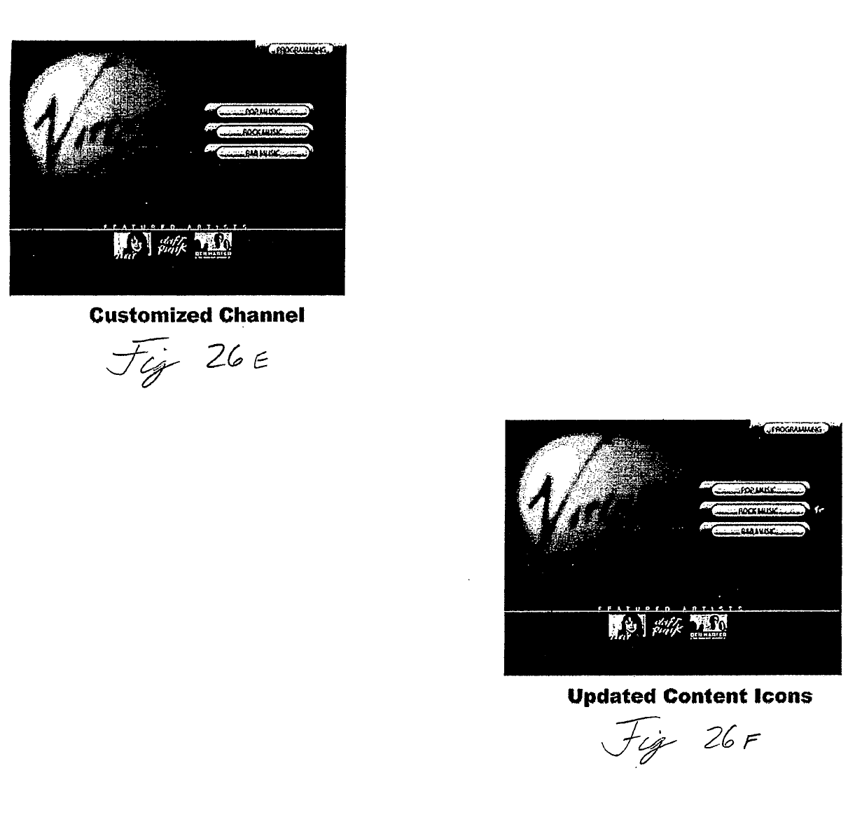

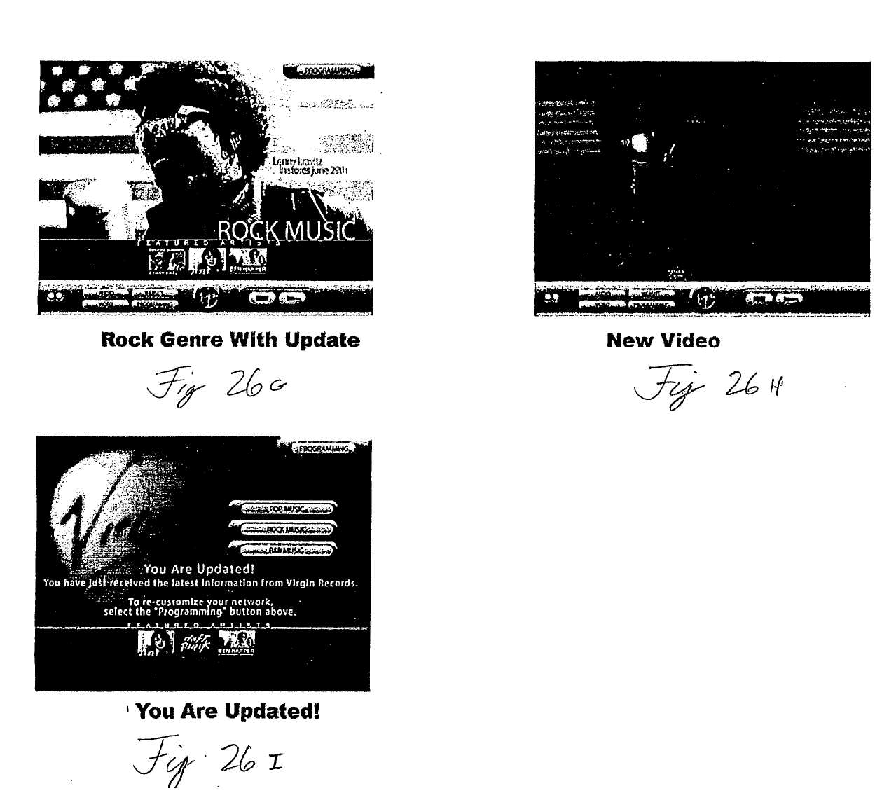

FIGS. 25a-l depict a series of user interfaces according to the execution of one implementation of the subject invention, showing a sequence of screen interfaces suitable for the creation of a shopping list of cosmetic supplies, via selection of various products by drilling through GUI interfaces 2510 of FIG. 25B to GUI 2512 of FIG. 25c, with the list created and displayed via GUI interface 2514 of FIG. 25D. Further products may be selected via GUI 2516 of FIG. 25E. These interfaces may be integrated with other GUI controls of the present invention, e.g. Audio menu 412 shown in FIG. 25L and Video menu 512 shown in FIG. 25M. A suitable interface sequence suitable for a music publisher is shown in FIGS. 26A-26I.

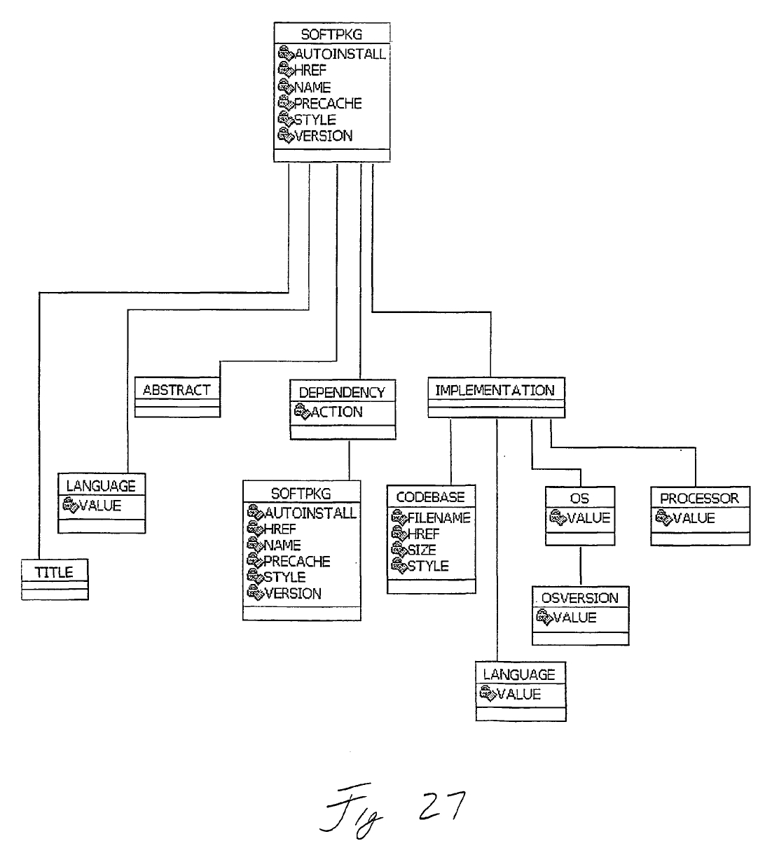

FIG. 27 depicts a suitable class implementation of the OSD aspect of the invention.

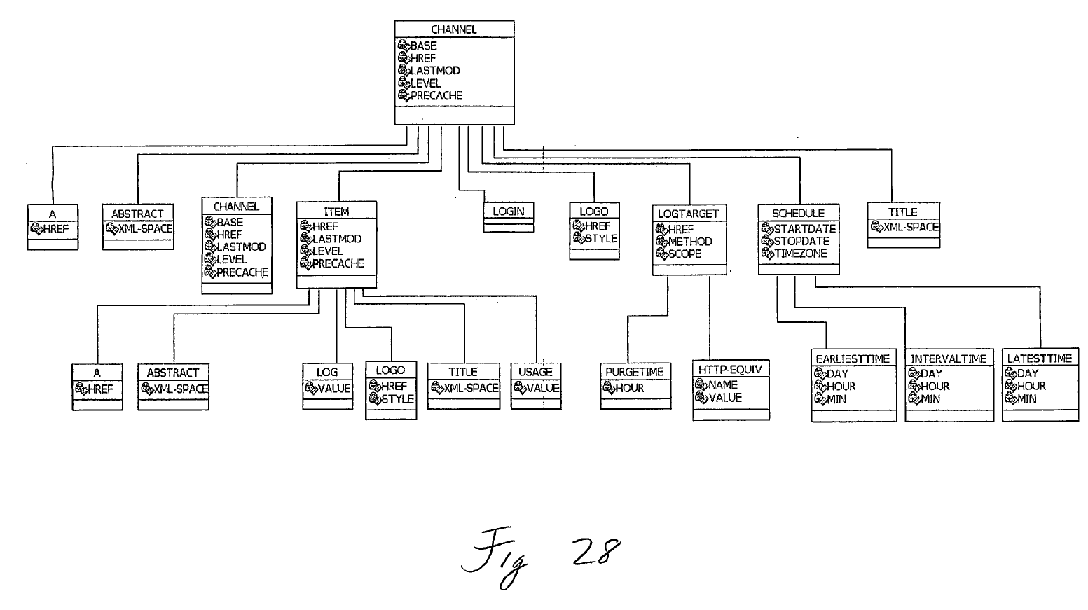

FIG. 28 depicts a suitable class implementation of the CSF aspect of the invention.

In an embodiment of the present invention in which the advertiser or content provider is a financial services provider or represents an investment opportunity, the present invention may be expected to lead to more informed, timely investment decisions. hi a preferred embodiment of the present invention, it is not necessary that the Server Administrator administer a traditional web site, because the focus of the Server Administrator is active, providing a client user personalized channel of two-way information. The data-mining information flow to the Server Administrator allows better than TV-quality transmission of information to a known consumer who becomes known to a greater degree over time, leading to increasingly efficient marketing. Because the content is provided in an attractive multimedia format, the attention of the client user is captured more easily than with email, which may be lost in a large volume of such messages.

The present invention also admits of application to intra-company communications, replacing or augmenting an existing intranet. Similarly, an audio, video and graphic two-way shareholder broadcast network could be provided to conduct remote shareholder meetings.

The present invention thus integrates the best features of traditional marketing and communication practices with the targeted, interactive, and timely attributes of the Internet, delivers to a pre-selected consumer information that the consumer has affirmatively requested and enables, providing TV-quality multimedia on a desktop without a broadband connection. The targeted nature of the transmission provides the information flow at low cost.

A system according to the present invention may operate in one embodiment as follows. A consumer may insert and install a pre-encoded CD into their computer, or access the website of the Server Administrator or an advertiser server and download and install the broadcast code. Alternately, the code may already be pre-embedded on a recording medium in the computer, PDA, WAP, or other digital device, to establish a broadcast channel. Upon completion of the transmission, the client user is alerted by an icon, particularly one that is adapted to the identity of the advertiser, to new content that is immediately available on their system. The channel thus created is a resilient, non-expiring link between the advertiser or other content provider, and the client user.

At the Server Administrator facility, intelligent agent controls are used to provide the content transmission to specific “tagged” client machines using bandwidth that may be considered “spare.” If client user activities so dictate, the transmission rate will preferably be throttled back so as not to interfere with competing client user activities. The client PC is “tagged” upon installation of the Server Administrator client software. Each client user request may be matched with relevant content by means of this tagging identification. In this fashion, traditional stand-alone media advertisements may be replaced by targeted campaigns that may continue over a period of time. The client user, such as a consumer, is receptive to this information because he may select with 100% accuracy the information they wish to receive.

In one embodiment of a promotional system according to the present invention, the Server Administrator can assist in supply chain management and maintenance with timely information updates and product alerts. The present invention, in certain embodiments, also admits of application to communications internal to an entity, such as a corporation or university. Development of a browser-based intranet is typically expensive and suffers from long lead times. However, by implementing an internal communication system using the present invention, the entity may eliminate much of this lead time and start-up cost. The administrator of the server implemented according to the present invention may be engaged to tailor its broadcast code to enable an intra-corporate communication system.

In a preferred embodiment, the provider of the Server Administration services does not create content, but may provide a marketing program or content distribution system to a advertiser's marketing department, for example.

According to this embodiment, the Service Administrator may license or sublicense the technology and provide integration of the multimedia content supplied by the advertiser. After the content is supplied by the advertiser or other content provider, the client-branded application may reside, for example, on the advertiser's server. In an alternate embodiment, the content may also reside on the Server Administrator facilities, in a hosting arrangement.

Regardless of where the content resides, preferably the encoding of the content will be performed by the Server Administrator. The advertiser or content developer will submit the content to the Server Administrator, and in some cases, may license the content for distribution by the Server Administrator. In a typical embodiment, the Server Administrator will then maintain and update the content in accordance with the new content developed by the content provider, according to the content providers marketing plan, promotions, or future content distribution. The unique knowledge of client users that may be attained by the Server Administrator may be applied to create personalized marketing approaches or at the least very fine-scale marketing approaches based on a narrow demographic group to which the user belongs.

According to one embodiment of the present invention, CDs or other optical or digital media may be created for clients, including entities not engaged in the publication of music or phonorecords. For example, an entity may wish the server administrator to provide hosting and bandwidth services.

In a preferred embodiment of the present invention, the administrator of the server will not be responsible for the creation of content. Instead, the client or customer of the server administrator will be directly responsible for providing content. The Server Administrator may earn revenues, for example, from royalties based on the frequency of the transmission. If the client requires content owned by third parties, the server administrator may under this model indicate that the client is responsible for purchasing/licensing additional content if required, with the server administrator giving technical advice to its clients on integrating its technology and multi-media solution. In an alternative embodiment, the server administrator may be affiliated with or also administer a content creation/production entity or facility, providing for the administration of more closely integrated content that is designed from its initial stages for tight integration with the media distribution embodiment of the present invention.

In a preferred embodiment, the software application of this invention is preferably included as a component of a comprehensive system, that includes the client user, a corresponding dedicated server site, and optionally, integrated and/or affiliated third party sites, which can include those having a working relationship with the dedicated server site. In use, the software user can load the software (e.g., automatically, by inserting a music CD or DVD containing the software), which will immediately prompt the user's computer to load the software application and provide access to that comprehensive system.

Once loaded, the software permits the user to access any desired component or function. Simultaneously, via the dedicated server site, information can be “pushed” to the user and/or “pulled” by the user, from the online dedicated site or beyond. Typically, for instance, the dedicated server site will have its own stored database of information regarding the recording artist, and can provide such information to the user in either a prompted (or requested) or unprompted manner. Similarly, the server site can, and typically will, have established a working relationship with third party sites, such as ticket providers or that of the artist or record label. Such relationships can serve to provide the server site with continual updates of information, to be stored at the server site. Additionally, the user can link to other, non-affiliated third party sites, by means of the external browser interface, or the integrated links on the user interface of the application.

As a result of these various features, the user can himself control the display of information and media being presented, while at the same time a variety of targeted commerce can be delivered and made available to him, e.g., based on immediate requests, user profiles (e.g., the user's history, as recorded at the server site), user preferences, collective preferences (as generated by consumer profiles and similarities), and the like.

Preferably, a server implementing the present invention will be supplied with security measures that will protect client and consumer information that may be stored or administered by the server. Such security measures include, but are not limited to, round-the-clock physical security at the server physical plant with restricted access, encryption of information using SSL or a similar key system, and firewall protection of the server.

A preferred embodiment of the present invention provides a software application for providing a multimedia presentation, the application comprising a media player component and a browser component. The media player component (and corresponding window(s)) can include, for instance, one or more of the following window modes: audio (e.g., for local CD/DVD tracks), video (e.g., for local CD/DVD tracks), pictures (e.g., local CD stills), text (e.g., local CD HTML) and a personal jukebox (e.g., customized media through the dedicated server web site). The browser component (and corresponding window(s)) can include one or more of the following window modes: audio (e.g., web tracks), video (e.g., web tracks), pictures (e.g., web stills) and text (e.g., web HTML).

The media player can provide one or more modes, e.g., selected from the group consisting of audio (e.g., CD, DVD, mp3) modes, video modes, and graphics modes (e.g., pictures and text, as well as roll-by, graphic equalizer, or oscilloscope displays). The WIP page approach described herein provides the player(s) in a form that is integrated with the browser itself, so as to permit topical information to be “pulled” from secondary sources (the dedicate server or other sites) by the application itself, or by the user, while also continually or periodically monitoring such sources via the Internet for further relevant information. The WIP page approach includes, therefore, an internal browser component, integrated with the player component (windows in player) and an interface, integrated with the player component, and adapted to access an external browser.

As described herein, the software application is preferably provided in combination with at least one audio, visual or graphics (e.g., texture, equalizer) selection. For instance, the software application can be included on a CD or DVD music album in order to permit the user to play various selections on the CD/DVD in a manner that permits the simultaneous display of lyrics, and/or that permits the user to access a variety of other information regarding the recording group.

When in the context of music, the audio is preferably songs, the video may be selected, inter alia, from music videos, concerts, and interviews, and the corresponding textural content is preferably selected from lyrics, and graphic equalizers. In such a context, the information is provided either online or from local content and is selected from artist information, music or video information, fan club information, tour schedules and ticket information and ordering capabilities, catalog information and interactive ordering capabilities, photographs, biographies, credits, and other information.

Such information can be provided from or by a variety of sources, including by the application provider, by affiliated (e.g., integrated) information providers, by Internet information providers, and by networked information providers (e.g., using peer-to-peer linkages and related information-transfer mechanisms).

The application of the present invention provides a variety of independent and/or interactive functions in a single e-commerce engine, including the access and display CD/DVD audio and/or visual, digital audio, digital video, as well as graphics. The application provides the features of the web, and more, without necessarily involving the “look and feel” of a conventional web browser. Rather, the application permits and provides the “look and feel” of the application provider, in a manner that permits intelligent and reactive coordination and targeting of electronic commerce.

In a related embodiment, the digital recording medium can include only one or more components of the application software, in order to permit that application to be loaded on a resident computer for later use. In an alternative, but related embodiment, the digital recording medium can include only one or more digital audio, video and/or graphics data packets, adapted to be integrated with application software provided previously or separately.

Using an example in which both audio/video/graphics and the software application are provided on the same digital (e.g., CD) medium, the user can load the medium into a multi-session CD-ROM drive and initiate the programs contained thereon. The user can access digital audio and/or video tracks and the selections contained therein, by an on-screen interface provided as part of the player software component. The icon-based choice to the user provides access to one or more areas, and by clicking on the icon, the interface instructs the resident computer (or server site) to play the indicated selection. The audio/video selection resides within the region as a plurality of data/application files capable of being played on a CD-ROM player in combination with a personal computer.

The software application of this invention can be used in any suitable mode, e.g., with real-time multimedia applications, including both two-way interactive multimedia and one-way streaming multimedia. In one-way streaming, the information flow is largely one-way from a server to a client, except for information sent by the client to control the streaming (e.g., VCR-like controls such as fast forward, reverse, retransmission requests, etc.). The end-to-end delay requirements are less stringent for one-way streaming than for two-way interactive multimedia, but are more strict than for non real-time data applications. For instance, the client can provide audio, video and/or graphics to others, including to the server or to other clients on the network or system.

In a preferred embodiment of the present invention, a client player will be provided to the client user or machine, as described herein. Using this client player. The client player will preferably present a product-focused interface, i.e., one that is designed for the incorporation of advertising content and media. In addition, CD/DVD-audio, digital audio, and digital video may also be executed. The client player preferably is tied to an e-commerce engine or server, and the player may be provided with GUI elements that may be executed to effect e-commerce transactions that may be related to the advertising or other media being executed on the client player. If music is being played with the client player, the player is also preferably supplied with data pertaining to the music that is may display for the user. This may be lyrics highlighted or indicated in synchronization with the music ala Karaoke, or may be a music score engine or chord progression built in with audio and video play for simultaneous play. The music score or chord may be supplied with a cursor or line showing progression through the notation.

Live event presentations may preferably be targeted from the CD/DVD or the application itself when the application is encoded on the computer or digital device. For example, the user puts a CD/DVD in their computer, the application recognizes that the user is listening to a particular artist and at that same time the artist has a live Internet event occurring simultaneously. The application will then prompt the user to access the event if they desire.

In an embodiment of the present invention, related material may be organized in an automated fashion, according to various criteria, which may be client user-selected. For example, data may be categorized and grouped under the types CD/DVD audio, CD/DVD digital video, Internet digital audio, and Internet digital video. These groupings may be primary or secondary keys or groupings, with subsidiary or overarching groupings by artist or style of music. Preferably, this grouping is automated, e.g. by file header information, to present a seamless interface to the user. For example, in the event that the user would be interested in a particular song by an artist from the Server Administrator disk, the application would not only allow the user listen to the song, but also would preferably show the user the music video on the disk and similar multimedia data such as the concert version, for example loaded on the client machine via the Internet, while simultaneously making related products, for example, media or merchandise related to that artist, available for purchase.

When using the Server Administrator player, either to play the Server Administrator disks or disks not published or distributed by the Server Administrator, the player will preferably have targeted advertisements both in what may be termed the advertising-insertion model, (e.g. “Buy Coepsi Soda”), according to targeted-demographics, for example, and in a mode that may be referred to as an e-commerce model (other related sellable material, e.g. “Synchronized Boys new CD is available”). These advertisements may be implemented, for example, in text, audio, video, and graphic formats.

The present invention may preferably be implemented according to an automatic “skinned” or themed player from the web-site—by means of XML (extensible Markup Language) download architecture for example, the player look and feel can be downloaded and dynamically created or modified according to user interest. Specifically, the content of material (music/movie) may generate automatically players with themes appropriate to the type of media in which the client user shows interest.

The present invention also provides, in a preferred embodiment, for a “Windows in Player” (WIP) interface designed to integrate multiple web browsers into the application in a manner transparent to the client user. This multiple browser-instance generation enables the provision of dynamic web content without notifying the user of a context switch from static local content (on the disk, chip, hard drive or other recording medium) to dynamic content that has been loaded from the Server Administrator server or other web server.

Upon placing a CD in the CD Drive of his/her PC, the user is provided with the ability to navigate to the Media Player Window component or the Browser Window Component. Both players access a local XL database to retrieve data such as skin information, local content (lyrics, track info, etc.), graphics, etc. Both players can also launch the default browser (Internet Explorer, Netscape Navigator, etc.). The Browser Window Player can seamlessly display local content and online web content in WIP pages.

In the course of operating the client PC, the media player window(s) provides a customizable graphics format (skin) adapted to play both web and local digital media. The browser window(s), in turn, provides a customizable graphics format (skin) as well. The web pages are available only to CD-specific players, and is available to load both local digital and/or web content. Optionally, the application provides optional links to outside web pages, displayed through an outside browser such as the current versions of Microsoft Explorer or Netscape. The dedicated server site maintains, or can access, one or more databases, adapted to provide a feed of related information or media to the client.

In a preferred embodiment of the present invention, dynamic content may be taken from the web and merged in a more or less synchronized fashion with static local content stored in typically read-only fashion on the CD/DVD to create a dynamic appealing user interface in the player, while requiring minimal bandwidth. The current invention thus uses the local CD/DVD content to augment, update, and/or replace the light downloaded graphics with heavy graphics that are more appealing to the user.

A broad process flow diagram is provided in FIG. 24, which is shown (and also provided) broken into individual frames of FIGS. 24a, 24b, and 24c. The process stages, where suitable, are depicted by means of a representative GUI interface schematic diagram. In FIG. 24, “Install Prompt” routine 2412 portion provides the user with the opportunity to cancel the installation of the client software. Such a prompt can be in any suitable form, e.g., those available under the “InstallShield” or “Wise” tradenames. At the “Intro Sequence” 2414, the application provides a “one time” opportunity, after an initial install, to provide a relevant message, e.g., to promote the artist, the server site, or some other feature, product, service, or entity. Such an opportunity will preferably attract the attention of the user via high-quality graphics, animation, or other video.

Continuing with FIG. 24b, the “First Open Audio” 2416 is the “player” that is first launched when an application disc is inserted in a drive, or following the “Intro Sequence” 2414 after an initial install 2412. In an embodiment of the present invention transmitting and promoting music, for example, the “CD Cover Art” area 2418, for instance, could provide a picture of the music CD or some other default graphic. The “First Open WIP Window” 2420 is the interface, or what the client user perceives as the “player” that is first launched when an application disc is inserted in a drive, or following the “Intro Sequence” 2414 after an initial install 2412. The player interface may preferably display and tout the technology either through video or Flash animation or a suitable alternative animation, such as animated .gif files, for example, as well as text and audio.

The “Audio”, as shown at 2422 in FIG. 24c represents the “player” that is geared for the audio portion of the application. It can provide standard audio controls as well as other standard application controls (listed below). The Lyrics area 2424 can display the lyrics of the current song player, including in a synchronized Karaoke style, as well as CD Cover Art, or a default graphic. The “Video” feature 2426 is the GUI aspect of the “player” that is geared for the video portion of the application. It can provide standard video controls 2428 as well as other standard application controls (listed below). The video display area can display the video or a default graphic.

The “WIP Promo” feature 2430 is the GUI aspect of the “player” that is designed for the seamless presentation of local content (gallery/bios, lyrics, contact info, etc.) and online web content.

As standard controls, the application preferably provides a “Brand Name” feature 2430 that allows for branding of the application such as the title of the CD, or other advertiser utilizing the services of the Server Administrator. The “Menu Base” 2432 is the main menu which is available at all times and allows navigating between the other components or players. The “Promo Icon” 2434 is a GUI button, preferably with a logo promoting a sponsor for the player, for instance, it could represent a retailer or some other sponsor promoting based on the genre of the artist of the disc. Executing, e.g., by cursor-pressing, Promo Icon 2434 will redirect to the appropriate Web Site either through a WIP page 2430 or launching the client's default browser (e.g. Internet Explorer, Netscape Navigator, etc.). The “Ticker” 2436 allows for non-obtrusive advertising. Executing this “Ticker” will redirect to the appropriate Web Site either through a WIP page or launching the client's default browser (e.g. Internet Explorer, Netscape Navigator, etc.) .

The “Audio Controls” 2420 are preferably standard CD audio controls for play, stop, pause, volume, etc., and will typically be “grayed out,” i.e., unenabled, if a CD is not present in the drive. The “Video Controls” 2428 are preferably standard video controls for play, stop, pause, volume, etc. In a preferred embodiment of the GUI, there is provided an area for audio track or video information 2438 (for example, a track or video may be named “GHOST,” as depicted at 2440), as well as an area 2442 for a track counter (00:00). As depicted, the application preferably displays both Minimize 2444 and Close 2446 GUI buttons (depicted with a standard “-” & “X” legend, respectively). The “List” 2448 is a playlist, and may contain the tracks for a CD, a list of videos, or a list of MP3 audio files to play, while the “Full Screen” button 2450 allows the user to switch the video currently being viewed into a full-screen mode.

According to one embodiment of the current invention, a “Broadcast” executable code section is downloaded, preferably by affirmative action and express agreement by the user, that enables the Server Administrator, or alternatively an authorized advertiser, to transmit with the ability stop, start, and restart, i.e., to sync up the downloading process with the current state of completion of the file being transmitted. The transmitted information may include, for example, information that has been previously requested by the client user, including, for example, music, pictures, videos, lyrics, concert dates. In a preferred embodiment, the Server Administrator or licensed self-administering advertiser is notified the online status of particular client users of groups of such users. The invention provides for an interconnection between the hard drive of the local client machine and the content server. In this manner, the server is able to recognize where in the file the broadcast should resume in the event that the transmission is terminated. This prevents the scenario under which a file which is largely downloaded is overwritten by a new file write that is starting over fresh with the entire transmission. Accordingly, the transmissions, and their restart point if applicable, and the corresponding write location of each hard drive for each individual client participating is maintained and tracked; thus, the present invention thus avoids disconnection problems as can present themselves in the context of streaming media or download; specifically dropped packets and transmission termination. The above thus increases the quality of the viewing experience, and reduces the perceived Downloading Time from the perspective of the end user.

In a preferred embodiment of the subject invention, communication is done through a SOAP (Simple Object Access Protocol), in part to help reduce problems for client users behind firewalls that reject non-http communications. However, the present invention may be implemented in other distributed object protocols such as DCOM and CIS, using a object such as Remote Data Services DataSpace object to create instances of objects remotely. Alternatively, or CORBA and IIOP or CDR, or EDI (ANSI X.12 or EDIFACT) could be used to implement the present invention..

A suitable channel creation and control scheme may be used to implement the push aspect of the present invention, in conjunction with OSD, to administer software upgrades via the SOFTPKG element and children. In a preferred embodiment, CDF (Channel Definition Format) schemas, implemented over XML, may be used to control the creation of channels, the tagging of client user machines, scheduling of transmissions, and matching content to tagged client user machines, for example. Preferably, bandwidth throttling is implemented in order to reduce the obtrusiveness of the media transmission to the client user. In this context “bandwidth throttling” refers primarily to limiting the data push rate to the client machine during periods of heavy client bandwidth utilization, as opposed to throttling used to prevent client abuse or overutilization of a server, although this latter type of bandwidth throttling may be implemented as well.

One possible implementation of a CDF scheme thought suitable for the present invention is shown in Appendix A (implemented in a W3C xsd schema).; a corresponding OSD implementation thought suitable for the present invention is set forth as Appendix B.

FIG. 27 depicts the object basis for how a object persists from the transmission via XML-based protocols to C++ objects for the channel specifically as to OSD. This enables the transmission of objects implemented on the Server Administrator's server to be implemented on the client user machine. Naturally, other object-orientated languages, e.g., Java, lend themselves to implementation of the present invention.

Appendix C depicts a suitable XML implementation for transmission of Skin and Layout for display of Server Administrator objects in the application residing at the client machine. This can be used in conjunction with OSD in order to maintain updated applications and a common range of application versions at client machines.

In a preferred embodiment, the code provided to the client user integrates with an existing multimedia player using standards as the basis of the integration, for example, Microsoft Media Player, Real Networks, etc. The code supplied to the client user, either via download or via physical media such as a CD/DVD, the carrier of the code allows product identification and delivery of similar content by genre or interest. In contrast with web-based promotion of the prior art, the present invention provides for a system by which information about a product line or provider content can be updated dynamically either by the Server Administrator or by the advertiser. Furthermore, according to the present invention, the client user's library organization and structure is not disrupted by such content changes when the Server Administrator or the Content Provider decides to update information or data residing on the client user machine. Furthermore, the remote client software according to the present invention is integrated with the CD and multimedia player of the client user machine.

According to an embodiment of the present invention, the Server Administrator can transmit new product updates and information based upon user preferences or selections. This process is depicted in FIG. 25, depicting the creation of an update preference menu and shopping list creation utility that may be used with brick and mortar retailers, for example. As depicted in FIG. 25, this update selection and shopping list functionality may be coupled with an interactive utility that may be useful to the client user, in this case a consumer, as well as having promotional value. For example, in FIG. 25 a series of GUI elements are provided in series showing a cosmetic selection utility. In FIG. 25a, the client user is introduced to the network, which may have branding information according to the advertiser, as at 2505. The client user may be presented with GUI 2510 showing various related consumer elements, for example cosmetic products 2511 for selection and exploration. Upon selection of lip cosmetic product via execution of GUI button 2511, GUT interface 2512 to lip cosmetic product line may be presented, with a utility to simulate the application of the cosmetic product to client user photograph 2513. The client user may add the selected cosmetic product to an electronic or printable shopping list, that may be physically taken to a brick-and-mortar retail outlet, or may alternatively, for example, be transmitted via SMTP or the like to a store or Internet fulfillment center. Various other consumer and business segments admit of a selection utility according to the present invention, including but not limited to, automotive, music and film, apparel and fashion, tourism and travel, financial and investment, direct marketing and catalog sales, modeling agencies, sporting events and pursuits, video gaming, and photography. Whichever consumer or business element is selected by the client user, preferably the user may be alerted when new information that may be of interest becomes available, by means of activation of icon element 2516 of FIG. 25h indicating that new information is available for transmittal when the consumer next views the subject information.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computerized method of information distribution, comprising the steps of:
providing instructions for controlling a computer on a recording medium readable by the computer, said instructions providing both a multimedia player component and an integrated public network browser component, wherein the program permits a user to play one or more items of multimedia and to access the public network so that the access to the public network is transparent, and
distributing said instructions to at least one remote computer.

2. The method of claim 1, wherein the instructions are distributed by means of computer-readable physical media.

3. The method of claim 2, wherein the computer-readable physical media further contains multimedia content.

4. The method of claim 3 wherein the multimedia content is playable by the multimedia player component.

5. The method of claim 1, wherein the instructions are distributed by means of network communication media.

6. The method of claim 3, wherein the network communications media is a public network.

7. The method of claim 1, wherein the information distributed is promotional information.

8. The method of claim 2, wherein the computer-readable physical media comprises optical media.

9. The method of claim 6, wherein the computer-readable physical media comprises a DVD.

10. A method according to claim 1 wherein access to the public network is provided in the form of access to a server sites adapted to provide related content.

11. A method according to claim 2 wherein access to the public network further comprises a conventional browser.

12. A method according to claim 1, further comprising one or more items of multimedia content.

13. A method according to claim 4 wherein the multimedia content is selected from music and video and graphics pertaining thereto.

14. A method according to claim 1, wherein the player interface further comprises a remotely activatable content alert; and further comprising the step of remotely activating the content alert.

15. A method according to claim 14, wherein the player activatable content alert comprises an icon which may be executed by the remote user in order to begin the loading of multimedia content to at least one remote computer.

16. A method according to claim 14, wherein the multimedia content comprises promotional material regarding a product or service.

17. A method according to claim 16, further comprising the production of a list of products or services derived from the promotional material.

18. A system comprising a computer program according to claim 1, in combination with a dedicated server adapted to be linked by the browser in order to provide related content.

19. A computerized method of providing multimedia content, comprising the steps of
providing a recording medium readable by the computer;
providing a player on the recording medium for playing the multimedia component, said player having a browser component capable of providing content from a public network;
wherein the program permits a user to play one or more items of multimedia and to access the Internet in a manner transparent to the user.

20. A method of distributing multimedia content to at least one remote user, the method comprising the steps of:
providing computer instructions according to claim 1;
loading the computer instructions onto at least one client computer;
establishing a data communications connection between a computer network and the at least one client computer, and;
executing the computer instructions so as to play one or more items of multimedia content and simultaneously receive content from the computer network.
